(19) United States
(12) Patent Application Publication
(10) Pub. No.: US 2026/0103103 A1
(43) Pub. Date: Apr. 16, 2026

(54) DAY-AHEAD AND INTRA-DAY MULTI-TIME-SCALE OPTIMAL CONTROL METHOD FOR MICROGRID OF CHARGING-SWAPPING STATION

(71) Applicants: JIANGSU ELECTRIC POWER RESEARCH INSTITUTE CO, LTD., Nanjing (CN); STATE GRID JIANGSU ELECTRIC POWER CO, LTD. RESEARCH INSTITUTE, Nanjing (CN)

(72) Inventors: Zhigang YE, Nanjing (CN); Yubo YUAN, Nanjing (CN); Qiangsheng BU, Nanjing (CN); Lei GAO, Nanjing (CN); Wenfei YI, Nanjing (CN); Mingzhong ZHENG, Nanjing (CN); Mingshen WANG, Nanjing (CN); Fei LUO, Nanjing (CN); Ning GUO, Nanjing (CN); Zhiqiang PENG, Nanjing (CN)

(73) Assignees: JIANGSU ELECTRIC POWER RESEARCH INSTITUTE CO, LTD., Nanjing (CN); STATE GRID JIANGSU ELECTRIC POWER CO, LTD. RESEARCH INSTITUTE, Nanjing (CN)

(21) Appl. No.: 19/339,372

(22) Filed: Sep. 25, 2025

Related U.S. Application Data
(63) Continuation of application No. PCT/CN2025/119911, filed on Sep. 9, 2025.

(30) Foreign Application Priority Data
Oct. 15, 2024 (CN) 202411435925.9

(51) Int. Cl. B60L 53/64; B60L 53/51; B60L 53/63; B60L 53/80; G06Q 50/06; H02J 3/00

(52) U.S. Cl. CPC B60L 53/64; B60L 53/51; B60L 53/63; B60L 53/80; G06Q 50/06; H02J 3/003; H02J 3/004; H02J 2101/24; H02J 2103/30

(57) ABSTRACT

The provided is a day-ahead and intra-day multi-time-scale optimal control method for a microgrid of a charging-swapping station. The day-ahead optimal scheduling is aimed at minimizing a net electricity purchase cost. The intra-day rolling optimal scheduling is aimed at minimizing a sum of the net electricity purchase cost and energy deviation penalty costs for energy storage systems and a charging-swapping station between a day-ahead scheduling plan and an intra-day rolling scheduling plan. The real-time feedback adjustment control is aimed at minimizing a sum of power deviations of distribution transformers, the energy storage systems, and the charging-swapping station between the intra-day rolling scheduling plan and a real-time feedback control. The provided effectively solves the problem that fixed control modes lacking planning, flexibility, and adaptability are unable to guarantee their economic viability in the face of random fluctuations and significant forecast inaccuracies in renewable energy output and charging load.

### CROSS-REFERENCE TO THE RELATED APPLICATIONS

This application is a continuation application of International Application No. PCT/CN2025/119911, filed on Sep. 9, 2025, which is based upon and claims priority to Chinese Patent Application No. 202411435925.9, filed on Oct. 15, 2024, the entire contents of which are incorporated herein by reference.

### TECHNICAL FIELD

The present disclosure relates to a control method for a microgrid of a charging-swapping station, and in particular to a day-ahead and intra-day multi-time-scale optimal control method for a microgrid of a charging-swapping station.

### BACKGROUND

A charging-swapping station is typically connected to a 10 kV distribution network feeder through distribution transformers. The charging-swapping station is provided with distributed photovoltaic systems on the canopies of parking spaces and the roofs of lounges, along with distributed energy storage devices of a certain capacity. Thus, a photovoltaic generation, energy storage, and charging-swapping integrated microgrid is formed for the charging-swapping station. Through synergistic control among photovoltaic generation, energy storage, and charging-swapping, the overall economic efficiency of the microgrid's operation is enhanced. Currently, a set of fixed control strategies is adopted, including “self-consumption with surplus power fed into the grid” for photovoltaic generation, “charging during off-peak periods and discharging during peak periods” for energy storage, and “charging in sync with photovoltaic generation” for charging piles. While these control strategies can reduce the operating costs of the charging-swapping station to some degree, they lack planning, flexibility, and adaptability. This ultimately undermines their economic viability in the face of random fluctuations and significant forecast inaccuracies in photovoltaic generation, charging load, and other parameters.

### SUMMARY

### Technical Objective

In view of the above problem, the present disclosure proposes a day-ahead and intra-day multi-time-scale optimal control method for a microgrid of a charging-swapping station. The present disclosure can adaptively generate an economically optimal control strategy for the microgrid of the charging-swapping station in the face of random fluctuations and significant forecast inaccuracies in renewable energy output, charging load, and other parameters.

### Technical Solution

The day-ahead and intra-day multi-time-scale optimal control method for a microgrid of a charging-swapping station provided by the present disclosure includes following steps:
step 1: acquiring a day-ahead scheduling plan based on a day-ahead optimal scheduling model, where the day-ahead optimal scheduling model is configured to acquire, on a day before a scheduling control day, the day-ahead scheduling plan for a next day, according to short-term power forecast data of a next-day renewable energy output and short-term power forecast data of a next-day load, with an objective of minimizing a net electricity purchase cost;
step 2: acquiring an intra-day rolling scheduling plan based on an intra-day rolling optimal scheduling model, where the intra-day rolling optimal scheduling model is configured to acquire, on the scheduling control day, the intra-day rolling scheduling plan within a rolling time window, according to ultra-short-term power forecast data of a renewable energy output and ultra-short-term power forecast data of a load, with an objective of minimizing a sum of the net electricity purchase cost, an energy adjustment penalty cost for energy storage systems between the day-ahead scheduling plan and the intra-day rolling scheduling plan, and an energy deviation penalty cost for a charging-swapping station between the day-ahead scheduling plan and the intra-day rolling scheduling plan; and
step 3: acquiring a real-time control command based on a real-time feedback adjustment control model, where the real-time feedback adjustment control model is configured to acquire, on the scheduling control day, the real-time control command for a controllable component in a current time period, according to real-time monitoring data of the renewable energy output and a load power, with an objective of minimizing a sum of power deviations of distribution transformers, the energy storage systems, and the charging-swapping station between the intra-day rolling scheduling plan and the real-time control command.

An objective function of the day-ahead optimal scheduling model is:

$$min . {C}^{DA} = {\sum }_{i ∈ DT} {\sum }_{t ∈ {T}^{DA}} ( {λ}_{t}^{buy} {P}_{i , t}^{DT +} Δ t - {λ}_{t}^{sell} {P}_{i , t}^{DT -} Δ t )$$

where, C^{DA} denotes the objective function of the day-ahead optimal scheduling model; DT and T^{DA} denote a set of distribution transformers and a set of day-ahead scheduling time horizons, respectively; t is a loop variable, denoting a i-th time-step;

$${λ}_{t}^{buy}$$

and

$${λ}_{t}^{sell}$$

denote an electricity purchase price and an electricity sale price per unit energy at the t-th time-step, respectively;

$${P}_{i , t}^{DT +} and {P}_{i , t}^{DT -}$$

denote a power that a microgrid draws from an i-th distribution transformer and a power that the microgrid feeds back to the i-th distribution transformer at the t-th time-step, respectively; and Δt denotes a length of a scheduling time interval.

An objective function of the intra-day rolling optimal scheduling model is:

$$min . {C}^{Roll} = {\sum }_{i ∈ DT} {\sum }_{t ∈ {T}^{Roll}} ( {λ}_{t}^{buy} {P}_{i , t}^{DT +} Δ t - {λ}_{t}^{sell} {P}_{i , t}^{DT -} Δ t ) + {μ}^{ESdev} {\sum }_{i ∈ ES} {\sum }_{t ∈ {T}^{Roll}} \vert {E}_{i , cap}^{ES} {SOC}_{i , t}^{ES} - {E}_{i , cap}^{ES} \overline{{SOC}_{i , t}^{ES}} \vert + {μ}^{Swapdev} {\sum }_{b ∈ BUS} {\sum }_{t ∈ {T}^{Roll}} \vert {E}_{b , t}^{Swap} - \overline{{E}_{b , t}^{Swap}} \vert$$

where, C^{Roll} denotes the objective function of the intra-day rolling optimal scheduling model; T^{Roll} denotes a set of rolling time horizons; ES denotes a set of energy storage systems; b is a loop variable; BUS denotes a set of buses; μ^{ESdev} denotes an energy adjustment penalty cost coefficient per unit energy for the energy storage systems; μ^{Swapdev} denotes an energy adjustment penalty cost coefficient per unit energy for the charging-swapping station;

$${E}_{i , cap}^{ES}$$

denotes a capacity of an i-th energy storage system;

$${SOC}_{i , t}^{ES}$$

denotes a state of charge (SOC) level of the i-th energy storage system at the end of the t-th time-step in the intra-day rolling scheduling plan;

$$\overline{{SOC}_{i , t}^{ES}}$$

denotes a SOC level of the i-th energy storage system at the end of the t-th time-step in the day-ahead scheduling plan;

$${E}_{b , t}^{Swap}$$

denotes charged energy of the charging-swapping station connected to a bus b at the end of the t-th time-step in the intra-day rolling scheduling plan; and

$$\overline{{E}_{b , t}^{Swap}}$$

denotes charged energy of the charging-swapping station connected to the bus b at the end of the t-th time-step in the day-ahead scheduling plan.

An objective function of the real-time feedback adjustment control model is:

$$min . Δ {P}^{dev} = {\sum }_{i ∈ DT} \frac{\vert {P}_{i , {t}_{r}}^{DT} - \vert}{{P}_{i , max}^{DT}} + {\sum }_{i ∈ ES} \frac{\vert {P}_{i , {t}_{r}}^{ESch} - \vert + \vert {P}_{i , {t}_{r}}^{ESdch} - \vert}{{P}_{i , max}^{ES}} + {\sum }_{b ∈ BUS} \frac{\vert {P}_{b , {t}_{r}}^{Swap} - \vert}{{P}_{b , max}^{Swap}}$$

where, ΔP^{dev} denotes the objective function of the real-time feedback adjustment control model;

$${P}_{i , {t}_{r}}^{DT} , {P}_{i , {t}_{r}}^{ESch} / {P}_{i , {t}_{r}}^{ESdch} , and {P}_{b , {t}_{r}}^{Swap}$$

denote an actual control value for a power passing through the i-th distribution transformer, an actual control value for a charging/discharging power of the i-th energy storage system, and an actual control value for a charging power of the charging-swapping station connected to the bus b in a tᵣ-th time-step in real-time feedback adjustment control, respectively;

$$, / , and$$

denote a planned value for the power passing through the i-th distribution transformer, a planned value for the charging/discharging power of the i-th energy storage system, and a planned value for the charging power of the charging-swapping station connected to the bus b in the current tᵣ-th time-step in intra-day rolling optimal scheduling, respectively;

$${P}_{i , max}^{DT}$$

denotes a maximum active power capacity of the i-th distribution

$${P}_{i , max}^{ES}$$

denotes a maximum charging/discharging power of the i-th energy storage system; and

$${P}_{b , max}^{Swap}$$

denotes a maximum charging power of the charging-swapping station connected to the bus b.

In the intra-day rolling optimal scheduling model, a constraint for the renewable energy output is:

$${P}_{i , t}^{PV} = {P}_{i , t}^{PVforeID}$$

where,

$${P}_{i , t}^{PV}$$

denotes the renewable energy output of an i-th renewable energy system at the t-th time-step in the intra-day rolling optimization model, and

$${P}_{i , t}^{PVforeID}$$

denotes an ultra-short-term power forecast value for the renewable energy output;
In the intra-day rolling optimization model, a constraint for a charging power load of a charging pile is:

$${P}_{b , t}^{CP} = {P}_{b , t}^{CPforeID}$$

where,

$${P}_{b , t}^{CP}$$

denotes the charging power road of the charging pile connected to a bus b in the intra-day rolling optimization model; and

$${P}_{b , t}^{CPforeID}$$

denotes an intra-day ultra-short-term power forecast value for the charging power of the charging pile connected to the bus b;
a constraint for a power of a station service load is:

$${P}_{b , t}^{SL} = {P}_{b , t}^{SLforeID}$$

where,

$${P}_{b , t}^{SL}$$

denotes the power of the station service load connected to the bus b in the intra-day rolling optimization model; and

$${P}_{b , t}^{SLforeID}$$

denotes an intra-day ultra-short-term power forecast value for the power of the station service load connected to the bus b;
an overall operation constraint for the microgrid of the charging-swapping station is:

$${\sum }_{i ∈ DT ⋂ \{ b \}} {P}_{i , t}^{DT} + {\sum }_{i ∈ PV ⋂ \{ b \}} {P}_{i , t}^{PV} + {\sum }_{i ∈ ES ⋂ \{ b \}} ( {P}_{i , t}^{ESdch} - {P}_{i , t}^{ESch} ) = {P}_{b , t}^{CP} + {P}_{b , t}^{Swap} + {P}_{b , t}^{SL}$$

where,

$${P}_{i , t}^{DT}$$

denotes an active power of an i-th distribution transformer at the t-th time-step;

$${P}_{i , t}^{ESch} and {P}_{i , t}^{ESdch}$$

denote a charging power and a discharging power of an i-th energy storage system at the t-th time-step, respectively;

$${P}_{b , t}^{Swap}$$

denotes a charging power of the charging-swapping station connected to the bus b at the t-th time-step; DT∩{b} denotes a set of distribution transformers connected to the bus b; PV∩{b} denotes a set of photovoltaic systems connected to the bus b; and ES∩{b} denotes a set of energy storage systems connected to the bus b.

In the intra-day rolling optimal scheduling model, constraints for charging and discharging states of the energy storage systems are:

$${x}_{i , t}^{ESch} = \overline{{x}_{i , t}^{ESch}}$$

$${x}_{i , t}^{ESdch} = \overline{{x}_{i , t}^{ESdch}}$$

where,

$${x}_{i , t}^{ESch} and {x}_{i , t}^{ESdch}$$

denote a charging state and a discharging state of an i-th energy storage system at the t-th time-step within a rolling time cycle, respectively; and

$$\overline{{x}_{i , t}^{ESch}} and \overline{{x}_{i , t}^{ESdch}}$$

denote a planned charging state and a planned discharging state of the i-th energy storage system at the t-th time-step in the day-ahead scheduling plan, respectively;
a SOC constraint for the energy storage systems is:

$${SOC}_{i , 0 , {r}_{1}}^{ES} = {SOC}_{i , ini}^{ES}$$

$${SOC}_{i , 0 , {r}_{i}}^{ES} = ; {r}_{i} ∈ Roll ∖ \{ {r}_{1} \}$$

$${SOC}_{i , {t}_{end} , {\{ {r}_{i} \}}_{end}}^{ES} \geq {SOC}_{i , ini}^{ES}$$

where,

$${SOC}_{i , 0 , {r}_{1}}^{ES}$$

denotes a SOC of the i-th energy storage system at an initial time of a first rolling optimization cycle;

$${SOC}_{i , ini}^{ES}$$

denotes an actual SOC value of the i-th energy storage system at the beginning of a first time horizon;

$${SOC}_{i , 0 , {r}_{1}}^{ES} ,$$

rᵢ∈Roll\{r₁} denotes a SOC of the i-th energy storage system at an initial time of another rolling optimization cycle;

denotes an actual SOC of the i-th energy storage system at the end of a first time period of a previous rolling optimization cycle rᵢ−1; and

$${SOC}_{i , {t}_{end} , {\{ {r}_{i} \}}_{end}}^{ES}$$

denotes an ending SOC of the i-th energy storage system in a rolling optimization cycle {rᵢ}_{end} including a final time t_{end}.

In the real-time feedback adjustment control model, a constraint for the renewable energy output is:

$${P}_{i , {t}_{r}}^{PV} = {P}_{i , {t}_{r}}^{PVrt}$$

where,

$${P}_{i , {t}_{r}}^{PV}$$

denotes an output of an i-th renewable energy system in a current tᵣ-th time-step; and

$${P}_{i , {t}_{r}}^{PVrt}$$

denotes a real-time monitored value for the output of the i-th renewable energy system in the current tᵣ-th time-step;
In the real-time feedback adjustment control model, a constraint for a charging power of charging piles is:

$${P}_{b , {t}_{r}}^{CP} = {P}_{b , {t}_{r}}^{CPrt}$$

where,

$${P}_{b , {t}_{r}}^{CP}$$

denotes the charging power of all the charging piles connected to a bus b in the current tᵣ-th time-step; and

$${P}_{b , {t}_{r}}^{CPrt}$$

denotes a real-time monitored value for the charging power of all the charging piles connected to the bus b in the current tᵣ-th time-step;
In the real-time feedback adjustment control model, a constraint for a power of a station service load is:

$${P}_{b , {t}_{r}}^{SL} = {P}_{b , {t}_{r}}^{SLrt}$$

where,

$${P}_{b , {t}_{r}}^{SLrt}$$

denotes a real-time monitored value for the power of the station service load connected to the bus b at a time tᵣ.

The present disclosure provides a computer device, including a memory, a processor, and a computer program stored on the memory and executable on the processor, where the computer program is executed by the processor to implement the day-ahead and intra-day multi-time-scale optimal control method for a microgrid of a charging-swapping station.

The present disclosure provides a computer-readable storage medium, configured to store a computer program, where the computer program is executed by a processor to implement the day-ahead and intra-day multi-time-scale optimal control method for a microgrid of a charging-swapping station.

The present disclosure provides a computer program product, including a computer program and/or command, where the computer program and/or command is executed by a processor to implement the day-ahead and intra-day multi-time-scale optimal control method for a microgrid of a charging-swapping station.

### Advantageous Effects

Compared to the prior art, the present disclosure has the following advantages. First, the present disclosure, based on the day-ahead short-term power forecast data of the renewable energy output and load, models the operation constraints of components such as the grid-connected distribution transformers, energy storage systems, and the charging-swapping station, as well as power balance constraints, in the microgrid of the charging-swapping station. Thus, the present disclosure proposes the day-ahead optimal scheduling model for the microgrid of the charging-swapping station with the objective of minimizing the net electricity purchase cost. Second, the present disclosure, based on the intra-day ultra-short-term power forecast data of the renewable energy output and load, models the component operation and power balance constraints within each rolling optimization cycle in the microgrid of the charging-swapping station. Thus, the present disclosure proposes the intra-day rolling optimal scheduling model for the microgrid of the charging-swapping station. Its objective is to minimize the sum of the net electricity purchase cost and the energy deviation penalty costs for the energy storage systems and the charging-swapping station between the day-ahead scheduling plan and the intra-day rolling scheduling plan. Third, the present disclosure, based on measured renewable energy output and load data, models the component operation and power balance constraints during the real-time feedback adjustment in the microgrid of the charging-swapping station. Thus, the present disclosure proposes the real-time feedback adjustment control optimization model for the microgrid of the charging-swapping station. Its objective is to minimize the sum of the power deviations of the distribution transformers, the energy storage systems, and the charging-swapping station between the intra-day rolling scheduling plan and the real-time feedback control. Finally, the present disclosure combines day-ahead optimal scheduling, intra-day rolling optimal scheduling, and real-time feedback adjustment control. The day-ahead optimal scheduling is aimed at minimizing the net electricity purchase cost. The intra-day rolling optimal scheduling is aimed at minimizing the sum of the net electricity purchase cost and energy deviation penalty costs for the energy storage systems and the charging-swapping station between the day-ahead scheduling plan and the intra-day rolling scheduling plan. The real-time feedback adjustment control is aimed at minimizing the sum of the power deviations of the distribution transformers, the energy storage systems, and the charging-swapping station between the intra-day rolling scheduling plan and the real-time feedback control. The present disclosure effectively solves the problem that fixed control modes lacking planning, flexibility, and adaptability are unable to guarantee their economic viability in the face of random fluctuations and significant forecast inaccuracies in renewable energy output, charging load, and other parameters.

### BRIEF DESCRIPTION OF THE DRAWINGS

FIG. 1 is a typical structure diagram of a microgrid of a charging-swapping station;

FIG. 2 is a flowchart of day-ahead and intra-day multi-time-scale optimal control for the microgrid of the charging-swapping station in the present disclosure;

FIGS. 3A-3C show a measured power curve of a microgrid of a charging-swapping station in an embodiment; and

FIGS. 4A-4C show a comparative diagram of simulation results for a case study.

### DETAILED DESCRIPTION OF THE EMBODIMENTS

The following further describes the technical solutions of the present disclosure in detail with reference to the drawings and embodiments.

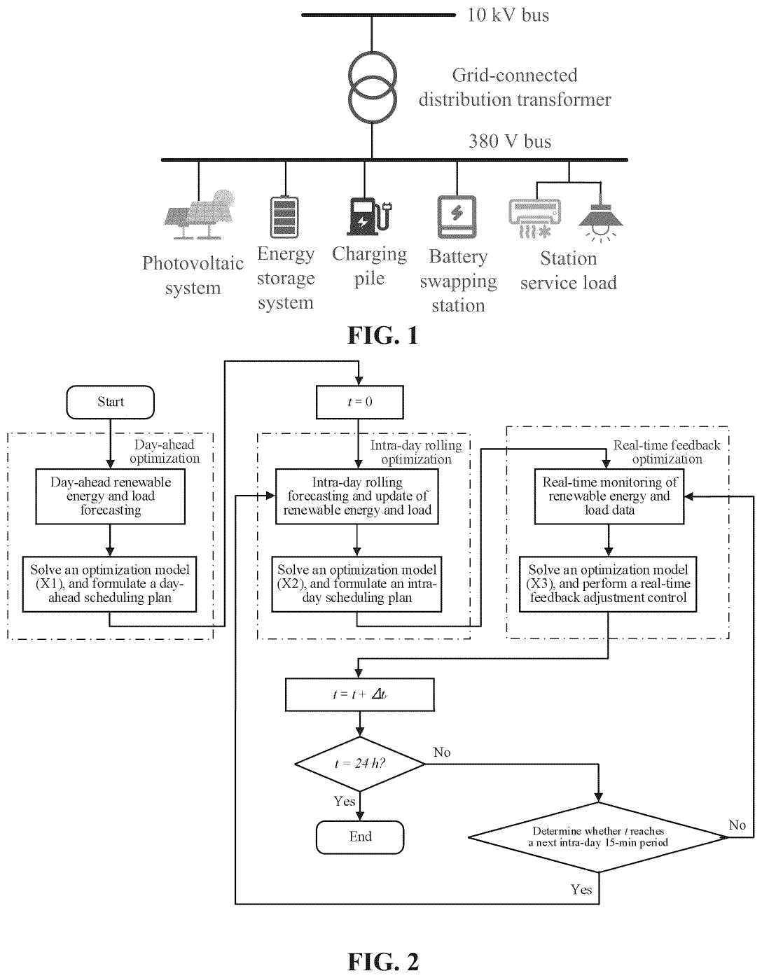

The typical structure of a microgrid of a charging-swapping station is shown in FIG. 1. The components mainly include grid-connected distribution transformers, photovoltaic systems, energy storage systems, charging piles, a charging-swapping station, and all station service loads including air conditioning and lighting.

In the present disclosure, a day-ahead and intra-day multi-time-scale optimal control method refers to an optimal control method under three different time scales, including day-ahead optimal scheduling, intra-day rolling optimal scheduling, and real-time feedback adjustment control. In this embodiment, regarding day-ahead optimal scheduling, on a day before a scheduling control day, based on day-ahead short-term power forecast values of a renewable energy output, a charging load, and a station service load, a day-ahead optimal scheduling model with a next day's 24-period time window as a time range and each 15-min interval as a time period is solved to acquire a scheduling control plan for each time period of the next day. Regarding intra-day rolling optimal scheduling, 15 min before an actual control on the scheduling control day, based on intra-day ultra-short-term power forecast values of the renewable energy output, the charging load, and the station service load, an intra-day rolling optimal scheduling model with a rolling time window (e.g., 4 h) as the time range and each 15-min interval as a time period is continuously solved in a rolling manner to acquire a scheduling control plan for each time period within a future time window. Regarding the real-time feedback adjustment control, during the actual control, based on real-time monitored power values of the renewable energy output, the charging load, and the station service load as feedback values, a real-time feedback adjustment control model is solved to acquire adjustment amounts and actual control values of controllable components such as the energy storage systems, the charging-swapping station, and the distribution transformers for the power scheduling plan in the current time period.

In the present disclosure, the specific flow of the day-ahead and intra-day multi-time-scale optimal control method for a microgrid of a charging-swapping station is shown in FIG. 2 and includes the following steps.
Step 1: A day-ahead scheduling plan is acquired based on a day-ahead optimal scheduling model. The day-ahead optimal scheduling model is configured to acquire, on a day before a scheduling control day, the day-ahead scheduling plan for the next 24 h at 15-min intervals, according to short-term power forecast data of a next-day photovoltaic output and short-term power forecast data of a load, with an objective of optimal economy.
Step 2: An intra-day rolling scheduling plan is acquired based on an intra-day rolling optimal scheduling model. The intra-day rolling optimal scheduling model is configured to acquire, on the scheduling control day, the intra-day rolling scheduling plan for a rolling time window at 15-min intervals, according to ultra-short-term power forecast data of a photovoltaic output and ultra-short-term power forecast data of a load, with an objective of minimizing a sum of a net electricity purchase cost and energy deviation penalty costs for energy storage systems and a charging-swapping station between the day-ahead scheduling plan and the intra-day rolling scheduling plan.
Step 3: A real-time control command is acquired based on a real-time feedback adjustment control model. The real-time feedback adjustment control model is configured to acquire, on the scheduling control day, the real-time control command for the controllable components in the current time period, according to real-time monitoring data of a photovoltaic output and a load power, with an objective of minimizing a sum of power deviations of the distribution transformers, the energy storage systems, and the charging-swapping station between the intra-day rolling scheduling plan and the real-time control command.

The technical solution of the day-ahead and intra-day multi-time-scale optimal control method for a microgrid of a charging-swapping station, which includes day-ahead scheduling, intra-day rolling optimal scheduling, and real-time feedback adjustment control, is described in detail below.

### (1) Day-Ahead Optimal Scheduling for the Microgrid of the Charging-Swapping Station

First, taking a typical structure of a microgrid of a charging-swapping station as the object, the component operation and power balance constraints for the day-ahead optimal scheduling of the microgrid of the charging-swapping station are introduced.

An operation constraint for grid-connected distribution transformers is modeled as follows:

$${P}_{i , t}^{DT} = {P}_{i , t}^{DT +} - {P}_{i , t}^{DT -} \qquad ( A1 )$$

$${x}_{i , t}^{DT +} + {x}_{i , t}^{DT -} = 1 \qquad ( A2 )$$

$$0 \leq {P}_{i , t}^{DT +} \leq {x}_{i , t}^{DT +} {P}_{i , max}^{DT} \qquad ( A3 )$$

$$0 \leq {P}_{i , t}^{DT -} \leq {x}_{i , t}^{DT -} {P}_{i , max}^{DT} \qquad ( A4 )$$

where,

$${P}_{i , t}^{DT}$$

denotes an i-th distribution transformer in a t-th time-step; the t-th time-step refers to a period of time after discretization, for example, for the future 24 h, each time period is 15 min, corresponding to 96 time periods;

$${P}_{i , t}^{DT +} and {P}_{i , t}^{DT -}$$

denote a power that a microgrid draws from the distribution transformer and a power that the microgrid feeds back to the distribution transformer, respectively;

$${x}_{i , t}^{DT +} and {x}_{i , t}^{DT -}$$

are 0/1 indicator variables, respectively indicating whether a power direction of the i-th distribution transformer at the t-th time-step is that the microgrid draws the power from or feeds back the power to the distribution transformer;

$${P}_{i , max}^{DT}$$

denotes a maximum active power capacity of the i-th distribution transformer; Eqs. (A1 to A2) indicate that the power flow direction of the distribution transformer is unique at any time, with a positive direction indicating that the microgrid draws the power from the distribution transformer and a negative direction that the microgrid feeds back the power to the distribution transformer; and Eqs. (A3 to A4) indicate that the power flowing through the distribution transformer does not exceed a maximum allowable power capacity of the distribution transformer.

A power constraint for photovoltaic generation is:

$${P}_{i , t}^{PV} = {P}_{i , t}^{PVforeDA} \qquad ( A5 )$$

where,

$${P}_{i , t}^{PV}$$

denotes an active power output of an i-th photovoltaic system at the t-th time-step;

$${P}_{i , t}^{PVforeDA}$$

denotes a day-ahead forecast power output of the i-th photovoltaic system at the t-th time-step; and Eq. (A5) indicates that in the day-ahead optimal scheduling model, the photovoltaic output equals a day-ahead short-term power forecast photovoltaic output (without considering photovoltaic curtailment).

An operation constraint for the energy storage systems is:

$$0 \leq {P}_{i , t}^{ESch} \leq {x}_{i , t}^{ESch} {P}_{i , max}^{ES} \qquad ( A6 )$$

$$0 \leq {P}_{i , t}^{ESdch} \leq {x}_{i , t}^{ESdch} {P}_{i , max}^{ES} \qquad ( A7 )$$

$${x}_{i , t}^{ESch} + {x}_{i , t}^{ESdch} \leq 1 \qquad ( A8 )$$

$${SOC}_{i , t}^{ES} = {SOC}_{i , t - 1}^{ES} + ( {P}_{i , t}^{ESch} {η}_{i}^{ESch} - {P}_{i , t}^{ESdch} / {η}_{i}^{ESdch} ) Δ t / {E}_{i , cap}^{ES} \qquad ( A9 )$$

$${SOC}_{i , min}^{ES} \leq {SOC}_{i , t}^{ES} \leq {SOC}_{i , max}^{ES} \qquad ( A10 )$$

$${SOC}_{i , 0}^{ES} = {SOC}_{i , ini}^{ES} \qquad ( A11 )$$

$${SOC}_{i , {N}^{T}}^{ES} \geq {SOC}_{i , ini}^{ES} \qquad ( A12 )$$

$${x}_{i , t}^{ESdch} \leq 1 - {x}_{d , t}^{DT -} ; i ∈ ES , d ∈ {DT}_{i} \qquad ( A13 )$$

$${\sum }_{t ∈ T} {u}_{i , t}^{ESch} \leq {N}_{max}^{ESch} \qquad ( A14 )$$

$${\sum }_{t ∈ T} {u}_{i , t}^{ESdch} \leq {N}_{max}^{ESdch} \qquad ( A15 )$$

$${u}_{i , t}^{ESch} + {u}_{i , t}^{ESdch} \leq 1 \qquad ( A16 )$$

$${u}_{i , t}^{ESch} + {u}_{i , t}^{ESdch} = {x}_{i , t}^{ESch} + {x}_{i , t}^{ESdch} ; t = 1 \qquad ( A17 )$$

$$\begin{matrix}\begin{matrix}{u}_{i , t}^{ESch} \leq {x}_{i , t}^{ESch} \\ {u}_{i , t}^{ESch} \leq 1 - {x}_{i , t}^{ESch}\end{matrix} \\ {u}_{i , t}^{ESch} \geq {x}_{i , t}^{ESch} - {x}_{i , t - 1}^{ESch}\end{matrix} \} ; t \geq 2 \qquad ( A18 )$$

$$\begin{matrix}\begin{matrix}{u}_{i , t}^{ESdch} \leq {x}_{i , t}^{ESdch} \\ {u}_{i , t}^{ESdch} \leq 1 - {x}_{i , t}^{ESdch}\end{matrix} \\ {u}_{i , t}^{ESdch} \geq {x}_{i , t}^{ESdch} - {x}_{i , t - 1}^{ESdch}\end{matrix} \} ; t \geq 2 \qquad ( A19 )$$

where,

$${P}_{i , t}^{ESch} and {P}_{i , t}^{ESdch}$$

denote charging and discharging power of an i-th energy storage system at the t-th time-step, respectively;

$${x}_{i , t}^{ESch} and {x}_{i , t}^{ESdch}$$

denote charging and discharging states (0/1 variables) of the i-th energy storage system at the t-th time-step, respectively;

$${P}_{i , max}^{ES}$$

denotes a maximum charging/discharging power of the i-th energy storage system;

$${SOC}_{i , t}^{ES}$$

denotes a SOC level on the i-th energy storage system at the t-th time-step;

$${SOC}_{i , t - 1}^{ES}$$

denotes a SOC level of the i-th energy storage system at a (t−1)-th time-step;

$${η}_{i}^{ESch} and {η}_{i}^{ESdch}$$

denote charging and discharging efficiencies of the i-th energy storage system, respectively;

$${E}_{i , cap}^{ES}$$

denotes a capacity of the i-th energy storage system; Δt denotes a length of a scheduling time interval (generally 15 min);

$${SOC}_{i , min}^{ES} and {SOC}_{i , max}^{ES}$$

denote minimum and maximum SOC levels of the i-th energy storage system, respectively; to make Eq. A9 applicable to all time periods t=1, 2, . . . , NT,

$${SOC}_{i , 0}^{ES}$$

denotes an initial SOC level of the i-th energy storage system;

$${SOC}_{i , {N}^{T}}^{ES} and {SOC}_{i , ini}^{ES}$$

denote ending and initial SOC levels of the i-th energy storage system within one scheduling cycle (generally 24 h), respectively;

$${x}_{d , t}^{DT -}$$

is a state indicator variable indicating whether a power of distribution transformer d connected to the i-th energy storage system is in reverse flow at the t-th time-step; ES denotes a set of energy storage systems; DTi denotes a set of distribution transformers connected to the i-th energy storage system;

$${u}_{i , t}^{ESch} and {u}_{i , t}^{ESdch}$$

are indicator states (0/1 variables) of whether the i-th energy storage system starts charging or discharging at the t-th time-step, respectively; T denotes an entire scheduling time range (24 h of the next day);

$${N}_{max}^{ESch} and {N}_{max}^{ESdch}$$

denote maximum allowed numbers of charging and discharging times for the energy storage system within the entire scheduling time range;

$${x}_{i , t - 1}^{ESch} and {x}_{i , t - 1}^{ESdch}$$

are charging and discharging states (0/1 variables) of the i-th energy storage system at the (t−1)-th time-step, respectively; Eqs. (A6 to A7) indicate that the charging and discharging power of the energy storage system does not exceed its maximum charging and discharging power; Eq. (A8) indicates that the charging and discharging states of the energy storage system are mutually exclusive in the same time period; Eq. (A9) denotes the energy-power balance relationship between the SOC and its charging and discharging power of the energy storage system; Eq. (A10) indicates that the SOC level of the energy storage system must be maintained within a certain range, for example, 10% to 100% of capacity; Eq. (A11) defines the initial SOC level of the energy storage system; Eq. (A12) indicates that the ending SOC level of the energy storage system is not lower than the initial SOC level; Eq. (A13) is a reverse power protection constraint for the energy storage systems, which restricts the energy storage systems from discharging when the power of the grid-connected distribution transformer is in reverse flow; Eqs. (A14 to A15) are constraints on the total number of charging and discharging times of the energy storage systems throughout the scheduling cycle, aiming to limit frequent charging and discharging of the energy storage system; Eqs. (A16 to A17) define the mutually exclusive constraints for the states of starting charging and starting discharging of the energy storage systems; Eq. (A18) describes a logical relationship between a logical variable for starting charging of the energy storage system and the charging state variable; and Eq. (A19) describes a logical relationship between a logical variable for starting discharging of the energy storage system and the discharging state variable.

A charging power constraint for the charging piles is:

$${P}_{b , t}^{CP} = {P}_{b , t}^{CPforeDA} \qquad ( A20 )$$

where,

$${P}_{b , t}^{CP}$$

denotes an active power output (aggregated value) of all charging piles connected to the bus b at the t-th time-step;

$${P}_{b , t}^{CPforeDA}$$

denotes a day-ahead forecast value for the charging power of all the charging piles connected to the bus b at the t-th time-step; and Eq. (A20) indicates that in the day-ahead optimal scheduling model, the charging power of the charging piles equals the day-ahead short-term power forecast value.

A charging constraint for the charging-swapping station is:

$$0 \leq {P}_{b , t}^{Swap} \leq {P}_{b , max}^{Swap} \qquad ( A21 )$$

$${E}_{b , t}^{Swap} = {E}_{b , t - 1}^{Swap} + {η}^{SwapCh} {P}_{b , t}^{Swap} Δ t \qquad ( A22 )$$

$${E}_{b , 0}^{Swap} = 0 \qquad ( A23 )$$

$${E}_{b , {N}^{T}}^{Swap} \geq {E}_{b , min}^{Swap} \qquad ( A24 )$$

where,

$${P}_{b , t}^{Swap}$$

denotes a charging power of the charging-swapping station connected to the bus b at the t-th time-step;

$${P}_{b , max}^{Swap}$$

denotes a maximum charging power of the charging-swapping station connected to the bus b;

$${E}_{b , t}^{Swap}$$

denotes charged energy of the charging-swapping station connected to the bus b at the t-th time-step;

$${E}_{b , t - 1}^{Swap}$$

denotes charged energy of the charging-swapping station connected to the bus b at the (t−1)-th time-step; η^{SwapCh} denotes a charging efficiency of the charging-swapping station connected to the bus b;

$${E}_{b , 0}^{Swap}$$

denotes charged energy of the charging-swapping station connected to the bus b at an initial time;

$${E}_{b , {N}^{T}}^{Swap}$$

denotes charged energy of the charging-swapping station connected to the bus b at an end time;

$${E}_{b , min}^{Swap}$$

denotes minimum charged energy that the charging-swapping station connected to the bus b must satisfy; Eq. (A21) indicates that the charging power of the charging-swapping station does not exceed the maximum charging power; Eq. (A22) denotes the energy-power balance relationship between the charged energy of the charging-swapping station and its charging power; Eq. (A23) indicates that the charged energy of the charging-swapping station at the initial time of the entire scheduling cycle is 0; and Eq. (A24) indicates that the charged energy of the charging-swapping station at the end of the scheduling cycle is not less than the minimum charged energy.

A constraint for a power of a station service load is:

$${P}_{b , t}^{SL} = {P}_{b , t}^{SLforeDA} \qquad ( A25 )$$

where,

$${P}_{b , t}^{SL}$$

denotes an active power or the station service load connected to the bus b at the t-th time-step;

$${P}_{b , t}^{SLforeDA}$$

denotes a day-ahead forecast value for the power of the station service load connected to the bus b; and Eq. (A25) indicates that in the day-ahead optimal scheduling model, the power of the station service load equals the day-ahead short-term power forecast value.

An overall operation constraint for the microgrid of the charging-swapping station is:

$${\sum }_{i ∈ DT ⋂ \{ b \}} {P}_{i , t}^{DT} + {\sum }_{i ∈ PV ⋂ \{ b \}} {P}_{i , t}^{PV} + {\sum }_{i ∈ ES ⋂ \{ b \}} ( {P}_{i , t}^{ESdch} - {P}_{i , t}^{ESch} ) = {P}_{b , t}^{CP} + {P}_{b , t}^{Swap} + {P}_{b , t}^{SL} \qquad ( A26 )$$

where, DT denotes the set of grid-connected distribution transformers; PV denotes the set of photovoltaic systems; ES denotes the set of energy storage systems; index b denotes the bus b; and Eq. (A26) indicates that power generation and power consumption maintain power balance at any time, which is the power balance constraint.

The objective of the day-ahead scheduling for the microgrid of the charging-swapping station is to minimize the net electricity purchase cost, which is expressed as follows:

$$min . {C}^{DA} = {\sum }_{i ∈ DT} {\sum }_{t ∈ {T}^{DA}} ( {λ}_{t}^{buy} {P}_{i , t}^{DT +} Δ t - {λ}_{t}^{sell} {P}_{i , t}^{DT -} Δ t ) \qquad ( 1 )$$

where, C^{DA} denotes a total cost of day-ahead scheduling optimization; DT and T^{DA} denote the set of grid-connected distribution transformers and the set of day-ahead scheduling time horizons, respectively;

$${λ}_{t}^{buy} and {λ}_{t}^{sell}$$

denote an electricity purchase price and an electricity sale price per unit energy, respectively; and Eq. (1) indicates that the total cost of day-ahead scheduling, i.e., the net electricity purchase cost, equals a difference between the electricity purchase cost and an electricity sale revenue.

The overall optimization model of day-ahead optimal scheduling for the microgrid of the charging-swapping station is shown in Eq. (X1):

$$( X 1 )$$

$$min . {C}_{DA} ( 1 ) \\ s . t . \{ \begin{matrix}Grid - connected transformer operation constraint \\ ( A 1 to A 4 ) \\ Photovolaic generation power constraint ( A 5 ) \\ Energy storage system operation constraint ( A 6 to A 19 ) \\ Charging pile charging power constraint ( A 20 ) \\ Charging - swapping station charging constraint \\ ( A 21 to A 24 ) \\ Station service load constraint ( A 25 ) \\ Power balance constraint ( A 26 )\end{matrix} \vert t ∈ {T}^{DA}$$

### (2) Intra-Day Rolling Optimal Scheduling for the Microgrid of the Charging-Swapping Station

Within the intra-day rolling time cycle (t∈T^{Roll}, Roll={r₁, r₂, . . . , rᵢ, . . . rₙ}, r1, r2, . . . ri, . . . rn denote the 1^{st} to n-th rolling optimization cycles, respectively), the constraint of the grid-connected distribution transformers is shown in Eqs. (A1 to A4).

Within the intra-day rolling time cycle, the photovoltaic output equals the ultra-short-term output forecast value, constrained by:

$${P}_{i , t}^{P V} = {P}_{i , t}^{PVforeID} \qquad ( B1 )$$

where,

$${P}_{i , t}^{P V}$$

denotes the photovoltaic output of the i-th photovoltaic system at the t-th time-step in the intra-day rolling optimization model; and

$${P}_{i , t}^{PVforeID}$$

denotes an ultra-short-term photovoltaic output forecast value.

In the intra-day rolling optimal scheduling model, the charging and discharging states of the energy storage systems remain consistent with the day-ahead scheduling plan, constrained by:

$${x}_{i , t}^{E S c h} = \overline{{x}_{i , t}^{ESch}} \qquad ( B2 )$$

$${x}_{i , t}^{ESdch} = \overline{{x}_{i , t}^{ESdch}} \qquad ( B3 )$$

where,

$${x}_{i , t}^{ESch} and {x}_{i , t}^{ESdch}$$

denote a charging state and a discharging state of an i-th energy storage system at the t-th time-step within the rolling time cycle, respectively; and

$$\overline{{x}_{i , t}^{ESch}} and \overline{{x}_{i , t}^{ESdch}}$$

denote a planned charging state and a planned discharging state of the i-th energy storage system at the t-th time-step in the day-ahead scheduling plan, respectively.

The SOC of the energy storage system at the initial time of the first rolling optimization cycle equals the initial SOC of the energy storage system. The SOC at the initial time of another rolling optimization cycle equals the actual SOC at the end of the previous time period (previous 15 min). The SOC at the end time of the rolling optimization cycle including the final time is not less than the initial SOC. The constraints are as follows:

$${SOC}_{i , 0 , {r}_{1}}^{E S} = {SOC}_{i , i n i}^{E S} \qquad ( B4 )$$

$${SOC}_{i , 0 , {r}_{i}}^{E S} = ; {r}_{i} ∈ Roll \backslash \{ {r}_{1} \} \qquad ( B5 )$$

$${SOC}_{i , {t}_{end} , {\{ {r}_{i} \}}_{end}}^{E S} \geq {SOC}_{i , ini}^{E S} \qquad ( B6 )$$

where,

$${SOC}_{i , 0 , {r}_{1}}^{E S}$$

denotes the SOC of the 1-th energy storage system at the initial time of the first rolling optimization cycle;

$${SOC}_{i , ini}^{E S}$$

denotes the actual SOC value of the i-th energy storage system at the beginning of a first time horizon;

$${SOC}_{i , 0 , {r}_{i}}^{E S}$$

denotes the SOC of the i-th energy storage system at the initial time of another rolling optimization cycle (a rolling optimization cycle other than the first rolling optimization cycle r1);

denotes the actual SOC of the i-th energy storage system at the end of the first time period of the previous rolling optimization cycle rᵢ−1; the first time period refers to a first 15-min time period (0 to 15 min); and

$${SOC}_{i , {t}_{end} , {\{ {r}_{i} \}}_{end}}^{E S}$$

denotes the ending SOC of the i-th energy storage system in the rolling optimization cycle {rᵢ}_{end} including the final time t_{end}.

In addition, the energy storage system still needs to satisfy the maximum charging/discharging power constraints (A6 to A7), the power-energy balance equation (A9), the SOC level constraint (A10), and the reverse power protection constraint (A13) for the energy storage system within the rolling the rolling time cycle t∈T^{Roll}.

In the intra-day rolling optimization model, the charging power load of the charging piles equals the ultra-short-term charging power forecast value, constrained by:

$${P}_{b , t}^{CP} = {P}_{b , t}^{CPforeID} \qquad ( B7 )$$

where,

$${P}_{b , t}^{CP}$$

denotes the charging power load of the charging piles connected to the bus b in the intra-day rolling optimization model; and

$${P}_{b , t}^{CPforeID}$$

denotes the intra-day ultra-short-term power forecast value of the charging power of the charging piles connected to the bus b.

In the intra-day rolling optimization model, the charging power of the charging-swapping station still needs to satisfy constraint (A21), and the power-energy balance equation between the charging power and the charged energy still needs to satisfy constraint (A22), but the time range becomes t∈T^{Roll}. The charged energy of the charging-swapping station at the initial time of the first rolling optimization cycle equals 0. At the initial time of each subsequent rolling optimization cycle, it equals the actual charged energy at the end of the previous time period (previous 15 min). The constraints are:

$${E}_{b , 0 , {r}_{1}}^{Swap} = 0 \qquad ( B8 )$$

$${E}_{b , 0 , {r}_{i}}^{Swap} = {E}_{b , 1 , {r}_{i - 1}}^{Swap} \qquad ( B9 )$$

where,

$${E}_{b , 0 , {r}_{1}}^{Swap}$$

denotes the charged energy of the charging-swapping station connected to the bus b at the initial time of the first rolling optimization cycle;

$${E}_{b , 0 , {r}_{i}}^{Swap}$$

denotes the charged energy of the charging-swapping station connected to the bus b at the initial time of the rolling optimization cycle ri; and

$${E}_{b , 1 , {r}_{i - 1}}^{Swap}$$

denotes the actual charged energy of the charging-swapping station connected to the bus b at the end of the first time period of the previous rolling optimization cycle ri−1.

The charged energy of the charging-swapping station at the end of the final time period is not less than the minimum charged energy, constrained by:

$${E}_{b , {t}_{end} , {\{ {r}_{i} \}}_{end}}^{Swap} \geq {E}_{b , min}^{Swap} \qquad ( B10 )$$

where,

$${E}_{b , {t}_{end} , {\{ {r}_{i} \}}_{end}}^{Swap}$$

denotes the charged energy of the charging-swapping station connected to the bus b at the end time of the rolling optimization cycle {rᵢ} end that includes the final time t_{end}.

In the intra-day rolling optimization model, the power of the station service load equals its ultra-short-term power forecast value, constrained by:

$${P}_{b , t}^{SL} = {P}_{b , t}^{SLforeID} \qquad ( B11 )$$

where,

$${P}_{b , t}^{SL}$$

denotes the power of the station service load connected to the bus b in the intra-day rolling optimization model; and

$${P}_{b , t}^{SLforeID}$$

denotes the intra-day ultra-short-term power forecast value of the power of the station service load connected to the bus b.

The microgrid of the charging-swapping station must satisfy the power balance constraint (A26) at any time. Therefore, at any t-th time-step t∈T^{Roll} of the intra-day rolling optimization model, the power balance constraint (A26) still needs to be satisfied.

The purpose of intra-day rolling optimization is to formulate the intra-day scheduling plan. The objective function of intra-day rolling optimal scheduling is to minimize the sum of the net electricity purchase cost, the penalty cost for feeding the power back to the microgrid from the photovoltaic systems, and the energy adjustment penalty cost for the energy storage systems:

$$min . {C}^{Roll} = {\sum }_{i ∈ DT} {\sum }_{t ∈ {T}^{Roll}} ( {λ}_{t}^{buy} {P}_{i , t}^{DT +} Δ t - {λ}_{t}^{sell} {P}_{i , t}^{DT -} Δ t ) + {μ}^{ESdev} {\sum }_{i ∈ ES} {\sum }_{t ∈ {T}^{Roll}} \vert {E}_{i , cap}^{ES} {SOC}_{i , t}^{ES} - {E}_{i , cap}^{ES} \overline{{SOC}_{i , t}^{ES}} \vert + {μ}^{Swapdev} {\sum }_{b ∈ BUS} {\sum }_{t ∈ {T}^{Roll}} \vert {E}_{b , t}^{Swap} - \overline{{E}_{b , t}^{Swap}} \vert \qquad ( 2 )$$

where, C^{Roll} denotes a total cost within the rolling time horizon; μ^{ESdev} denotes an energy adjustment penalty cost coefficient per unit energy for the energy storage systems; μ^{Swapdev} denotes an energy adjustment penalty cost coefficient per unit energy for the charging-swapping station; T^{Roll} denotes a set of rolling time horizons; BUS denotes a set of all buses;

$${E}_{i , cap}^{ES}$$

denotes a capacity of the i-th energy storage system;

$${SOC}_{i , t}^{ES}$$

denotes a SOC level of the i-th energy storage system at the end of the t-th time-step in the intra-day rolling scheduling plan;

$$\overline{{SOC}_{i , t}^{ES}}$$

denotes a SOC level of the i-th energy storage system at the end of the t-th time-step in the day-ahead scheduling plan;

$${E}_{b , t}^{Swap}$$

denotes charged energy of the charging-swapping station connected to the bus b at the end of the t-th time-step in the intra-day rolling scheduling plan;

$$\overline{{E}_{b , t}^{Swap}}$$

denotes charged energy of the charging-swapping station connected to the bus b at the end of the t-th time-step in the day-ahead scheduling plan; and the three terms in the summation on the right side of the equation in Eq. (2) denote the net electricity purchase cost, the energy adjustment penalty cost for the energy storage systems, and the energy adjustment penalty cost for the charging-swapping station within the rolling time horizon, respectively.

The overall optimization model for intra-day rolling optimal scheduling for the microgrid of the charging-swapping station is shown in (X2):

$$s . t . \{ \begin{matrix}min . {C}^{Roll} ( 2 ) \\ Grid - connected transformer operation constraint ( A 1 to A 4 ) \\ Photovoltaic generation power constraint ( B 1 ) \\ Energy storage system operation contraint ( B 2 to B 6 ) , ( A 6 to A 7 ) , ( A 9 to A 10 ) , ( A 13 ) \\ Charging pile charging power contraint ( B 7 ) \\ Charging - swaping station charging constraint ( B 8 to B 10 ) , ( A 21 to A 22 ) \\ Power balance constraint ( A 26 )\end{matrix} \vert t ∈ {T}^{Roll} \qquad ( X2 )$$

### (3) Real-Time Feedback Adjustment Control for the Microgrid of the Charging-Swapping Station

The real-time feedback adjustment control for the microgrid of the charging-swapping station involves a power control command for adjusting controllable components (including the energy storage systems, the charging-swapping station, and the distribution transformers) in the current time period (denoted as tᵣ) based on real-time monitored fluctuations in the renewable energy output and the load power. The time range for the real-time feedback control is 24 h intra-day, expressed as T^{RT}={1, 2, . . . , t_{end}}, and the time interval for the real-time feedback control is denoted by Δtᵣ (e.g., 1 min/5 min).

In the current time period tᵣ∈T^{RT} of the real-time feedback adjustment control, the distribution transformer still needs to satisfy the operation constraint (A1 to A4).

In the current time period tᵣ∈T^{RT} of the real-time feedback adjustment control, the photovoltaic output equals its real-time monitored value, constrained by:

$${P}_{i , {t}_{r}}^{PV} = {P}_{i , {t}_{r}}^{PVrt} \qquad ( C1 )$$

where,

$${P}_{i , {t}_{r}}^{PV}$$

denotes the output or the i-th photovoltaic system at the current tᵣ-th time-step; and

$${P}_{i , {t}_{r}}^{PVrt}$$

denotes the real-time monitored value for the output of the i-th photovoltaic system at the current tᵣ-th time-step.

In the current time period tᵣ∈T^{RT} of the real-time feedback adjustment control, the charging and discharging states of the energy storage systems remain consistent with the day-ahead/intra-day scheduling plan, constrained by:

$${x}_{i , {t}_{r}}^{E S c h} = \overline{{x}_{i , {t}_{r}}^{E S c h}} \qquad ( C2 )$$

$${x}_{i , {t}_{r}}^{E S d c h} = \overline{{x}_{i , {t}_{r}}^{E S d c h}} \qquad ( C3 )$$

where,

$${x}_{i , {t}_{r}}^{E S c h} and {x}_{i , {t}_{r}}^{E S d c h}$$

denote the charging and discharging states of the i-th energy storage system at the current tᵣ-th time-step in the real-time feedback adjustment control, respectively; and

$$\overline{{x}_{i , {t}_{r}}^{E S c h}} and \overline{{x}_{i , {t}_{r}}^{ESdch}}$$

denote the planned charging and discharging state values of the i-th energy storage system at the current tᵣ-th time-step in the day-ahead scheduling plan, respectively.

In the real-time feedback control, the initial SOC of the energy storage system in the initial time period (tᵣ=1) equals the initial SOC of the energy storage system for the entire scheduling cycle (24 h). The initial SOC in another time period (tᵣ≥2) equals the actual SOC at the end of the previous time period (previous 5 min/previous 1 min, depending on the time interval Δtᵣ for the real-time feedback control). The actual SOC at the end of the final time period (tᵣ=t_{end}) is not less than the initial SOC. The constraints are as follows:

$${SOC}_{i , 0 , {t}_{r}}^{E S} = {SOC}_{i , ini}^{E S} ; {t}_{r} = 1 \qquad ( C4 )$$

$${SOC}_{i , 0 , {t}_{r}}^{E S} = {SOC}_{i , {t}_{r} - 1}^{E S} ; {t}_{r} \geq 2 \qquad ( C5 )$$

$${SOC}_{i , {t}_{r}}^{E S} \geq {SOC}_{i , ini}^{E S} ; {t}_{r} = {t}_{e n d} \qquad ( C6 )$$

where,

$${SOC}_{i , 0 , {t}_{r}}^{E S}$$

denotes the initial SOC level of the i-th energy storage system at the current tᵣ-th time-step;

$${SOC}_{i , {t}_{r} - 1}^{E S}$$

denotes the actual SOC level of the i-th energy storage system at the end of the previous (tᵣ−1) time period relative to the current tᵣ-th time-step;

$${SOC}_{i , {t}_{r}}^{E S}$$

denotes the SOC level of the i-th energy storage system at the end of the current tᵣ-th time-step; and t_{end} denotes the final time period of the real-time feedback control.

In addition, the energy storage system still needs to satisfy the maximum charging/discharging power constraint (C7), the power-energy balance constraint (C8), and the SOC level constraint (C9) in the real-time feedback adjustment control, as shown below:

$$0 \leq {P}_{i , {t}_{r}}^{E S c h} \leq {x}_{i , {t}_{r}}^{E S c h} {P}_{i , max}^{E S} \qquad ( C7 )$$

$$0 \leq {P}_{i , {t}_{r}}^{ESdch} \leq {x}_{i , {t}_{r}}^{E S d c h} {P}_{i , max}^{E S} \qquad ( C8 )$$

$${SOC}_{i , {t}_{r}}^{E S} = {SOC}_{i , 0 , {t}_{r}}^{E S} + ( {P}_{i , {t}_{r}}^{E S c h} {η}_{i}^{E S c h} - {P}_{i , {t}_{r}}^{E S d c h} / {η}_{i}^{E S d c h} ) Δ {t}_{r} / {E}_{i , c a p}^{E S} \qquad ( C9 )$$

$${SOC}_{i , min}^{E S} \leq {SOC}_{i , {t}_{r}}^{E S} \leq {SOC}_{i , max}^{E S} \qquad ( C10 )$$

where,

$${P}_{i , {t}_{r}}^{E S c h} and {P}_{i , {t}_{r}}^{E S d c h}$$

denote the charging and discharging power of the i-th energy storage system at the tᵣ-th time-step in real-time feedback adjustment control, respectively;

$${x}_{i , {t}_{r}}^{E S c h} and {x}_{i , {t}_{r}}^{E S d c h}$$

denote the charging and discharging states (0/1 variables) of the i-th energy storage system at the tᵣ-th time-step in the real-time feedback adjustment control, respectively;

$${P}_{i , max}^{E S}$$

denotes the maximum charging/discharging power of the i-th energy storage system;

$${SOC}_{i , {t}_{r}}^{E S}$$

denotes the SOC level of the i-th energy storage system at the tᵣ-th time-step;

$${SOC}_{i , 0 , {t}_{r}}^{E S}$$

denotes the initial SOC of the i-th energy storage system at the tᵣ-th time-step;

$${η}_{i}^{E S c h} and {η}_{i}^{E S d c h}$$

denote the charging and discharging efficiencies of the i-th energy storage system, respectively;

$${E}_{i , cap}^{E S}$$

denotes the capacity of the i-th energy storage system; Δtᵣ denotes the time interval of the real-time feedback control (generally 5 min/1 min); and

$${SOC}_{i , min}^{E S} and {SOC}_{i , max}^{E S}$$

denote the minimum and maximum SOC levels of the i-th energy storage system, respectively.

In the real-time feedback control, the charging power of the charging piles equals their real-time monitored value:

$${P}_{b , {t}_{r}}^{CP} = {P}_{b , {t}_{r}}^{CPrt} \qquad ( C11 )$$

where,

$${P}_{b , {t}_{r}}^{CPrt}$$

denotes the charging power of all the charging piles connected to a bus b at the current tᵣ-th time-step; and

$${P}_{b , {t}_{r}}^{CP}$$

denotes the real-time monitored charging power value of all the charging piles connected to the bus b at the current tᵣ-th time-step.

In the real-time feedback control, the initial energy of the charging-swapping station at the initial time period (tᵣ=1) equals the initial energy of the charging-swapping station within the entire scheduling cycle (24 h), which is 0; the initial energy of the charging-swapping station in another time period (tᵣ≥2) equals the actual charged energy at the end of the previous time period (previous 5 min/previous 1 min, depending on the time interval Δtᵣ for the real-time feedback control); the actual charged energy at the end of the final time period (tᵣ=t_{end}) is not less than the minimum charged energy of the charging-swapping station; and the constraints are as follows:

$${E}_{b , 0 , {t}_{r}}^{S w a p} = 0 ; {t}_{r} = 1 \qquad ( C12 )$$

$${E}_{b , 0 , {t}_{r}}^{S w a p} = {E}_{b , {t}_{r} - 1}^{S w a p} ; {t}_{r} \geq 2 \qquad ( C13 )$$

$${E}_{b , {t}_{r}}^{S w a p} \geq {E}_{b , min}^{S w a p} ; {t}_{r} = {t}_{e n d} \qquad ( C14 )$$

where,

$${E}_{b , 0 , {t}_{r}}^{S w a p}$$

denotes the initial charged energy of the charging-swapping station connected to the bus b at the current tᵣ-th time-step;

$${E}_{b , {t}_{r} - 1}^{S w a p}$$

denotes the charged energy of the charging-swapping station connected to the bus b at the end of the previous (tᵣ−1) time period relative to the current tᵣ-th time-step; and

$${E}_{b , {t}_{r}}^{S w a p}$$

denotes the charged energy of the charging-swapping station connected to the bus b at the end of the current tᵣ-th time-step.

In addition, the charging-swapping station still needs to satisfy the maximum charging power constraint (C15) and the power-energy balance constraint (C16) in the real-time feedback adjustment control, as shown below:

$$0 \leq {P}_{b , {t}_{r}}^{S w a p} \leq {P}_{b , max}^{S w a p} \qquad ( C15 )$$

$${E}_{b , {t}_{r}}^{S w a p} = {E}_{b , 0 , {t}_{r}}^{S w a p} + {η}^{S w a p C h} {P}_{b , {t}_{r}}^{S w a p} Δ t \qquad ( C16 )$$

where,

$${P}_{b , {t}_{r}}^{S w a p}$$

denotes the charging power of the charging-swapping station connected to the bus b at the tᵣ-th time-step;

$${P}_{b , max}^{S w a p}$$

denoted the maximum charging power of the charging-swapping station connected to the bus b;

$${E}_{b , t}^{Swap}$$

denotes the charged energy of the charging-swapping station connected to the bus b at the t-th time-step;

$${E}_{b , t - 1}^{Swap}$$

denotes the charged energy of the charging-swapping station connected to the bus b at the (t−1)-th time-step; η_{Swapch} denotes the charging efficiency of the charging-swapping station;

$${E}_{b , 0}^{Swap}$$

denotes the charged energy of the charging-swapping station connected to the bus b at the initial time;

$${E}_{b , {N}^{T}}^{Swap}$$

denotes the charged energy of the charging-swapping station connected to the bus b at the end time; and

$${E}_{b , min}^{Swap}$$

denotes the minimum charged energy that the charging-swapping station connected to the bus b must satisfy throughout the scheduling cycle.

In the real-time feedback control, the power of the station service load is a real-time monitored value, constrained by:

$${P}_{b , {t}_{r}}^{SL} = {P}_{b , {t}_{r}}^{SLrt} \qquad ( C 17 )$$

where,

$${P}_{b , {t}_{r}}^{SLrt}$$

denotes a real-time monitored value for the power of the station service load connected to the bus b at a time tᵣ.

The overall operation of the microgrid of the charging-swapping station must satisfy power balance at any time. Therefore, in the real-time feedback control, the power balance constraint (A26) still needs to be satisfied.

The objective of the real-time feedback adjustment control for the microgrid of the charging-swapping station is to minimize the total deviation of the real-time control power of the distribution transformers, the energy storage systems, and the charging-swapping station compared to the power of the intra-day rolling scheduling plan, expressed as:

$$min . Δ {P}^{dev} = {\sum }_{i ∈ DT} \frac{\vert {P}_{i , {t}_{r}}^{DT} - \vert}{{P}_{i , max}^{DT}} + {\sum }_{i ∈ ES} \frac{\vert {P}_{i , {t}_{r}}^{ESch} - \vert + \vert {P}_{i , {t}_{r}}^{ESdch} - \vert}{{P}_{i , max}^{ES}} + {\sum }_{b ∈ BUS} \frac{\vert {P}_{b , {t}_{r}}^{Swap} - \vert}{{P}_{b , max}^{Swap}} \qquad ( 3 )$$

where, ΔP^{dev} denotes the objective function (i.e., a total power deviation) of the real-time feedback adjustment control for the microgrid of the charging-swapping station;

$${P}_{i , {t}_{r}}^{DT} , {P}_{i , {t}_{r}}^{ESch} / {P}_{i , {t}_{r}}^{ESdch} , and {P}_{b , {t}_{r}}^{Swap}$$

denote an actual control value for a power passing through the i-th distribution transformer, an actual control value for a charging/discharging power of the i-th energy storage system, and an actual control value for a charging power of the charging-swapping station connected to the bus b at a tᵣ-th time-step in the real-time feedback adjustment control, respectively;

$$, / , and$$

denote a planned value for the power passing through the i-th distribution transformer, a planned value for the charging/discharging power of the i-th energy storage system, and a planned value for the charging power of the charging-swapping station connected to the bus b at the current tᵣ-th time-step in the intra-day rolling optimal scheduling, respectively;

$${P}_{i , max}^{DT}$$

denotes a maximum active power capacity of the i-th distribution transformer;

$${P}_{i , max}^{ES}$$

denotes a maximum charging/discharging power of the i-th energy storage system, and

$${P}_{b , max}^{Swap}$$

denotes a maximum charging power of the charging-swapping station connected to the bus b.

The optimization model of the real-time feedback adjustment control for the microgrid of the charging-swapping station is shown as (X3):

$$\begin{matrix}min . Δ {P}^{dev} ( 3 ) \\ s . t . \{ \begin{matrix}Grid - connected transformer operation constraint ( A 1 to A 4 ) \\ Photovoltaic generation power constraint ( C 1 ) \\ Energy storage system operation constraint ( C 2 to C 10 ) \\ Charging pile charging power constraint ( C 11 ) \\ Charging - swapping station charging constraint ( C 12 to C 16 ) \\ Station service load constraint ( C 17 ) \\ Power balance constraint ( A 26 )\end{matrix}\end{matrix} \vert t = {t}_{r} \qquad ( X 3 )$$

### (4) Day-Ahead and Intra-Day Multi-Time-Scale Control Method for the Microgrid of The Charging-Swapping Station

Based on the day-ahead optimal scheduling model (X1), the intra-day rolling optimal scheduling model (X2), and the real-time feedback adjustment control optimization model (X3) for the microgrid of the charging-swapping station, a day-ahead and intra-day multi-time-scale control method for the microgrid of the charging-swapping station is proposed. The specific flow is shown in FIG. 2.

In FIG. 2, the day-ahead and intra-day forecasting of the renewable energy (distributed photovoltaic output) and the load (charging piles, station service power) adopts artificial intelligence (AI) algorithms such as long short-term memory (LSTM), support vector machine (SVM), and random forest (RF) regression. Through deep learning and mining of historical data, the forecast model is continuously improved using sample data training, and is combined with external parameters such as irradiance, temperature, and price, to achieve accurate forecasting of the renewable energy and load.

In FIG. 2, the optimization model (X1) is a mixed-integer linear programming (MILP) model, which can be solved using algorithms such as branch and bound, cutting plane, Benders decomposition, and Dantzig-Wolfe (D-W) decomposition. The optimization models (X2) and (X3) are linear programming (LP) models, which can be solved using a simplex method. These optimization algorithms are integrated in general-purpose solvers (such as Cplex and Gurobi). The global optimal solutions of the optimization models (X1 to X3) can be easily acquired by using programming languages such as C⁺⁺, Java, Python, and Matlab for modeling and calling the solvers.

The day-ahead and intra-day multi-time-scale control flow and implementation method of the present disclosure combine the day-ahead optimal scheduling, the intra-day rolling optimal scheduling, and the real-time feedback adjustment control. The present disclosure solves the problems of fixed control modes lacking planning, flexibility, and adaptability, and unable to guarantee economy under the condition of random fluctuations and significant forecast inaccuracies in parameters of the renewable energy and charging load.

### Simulation Case

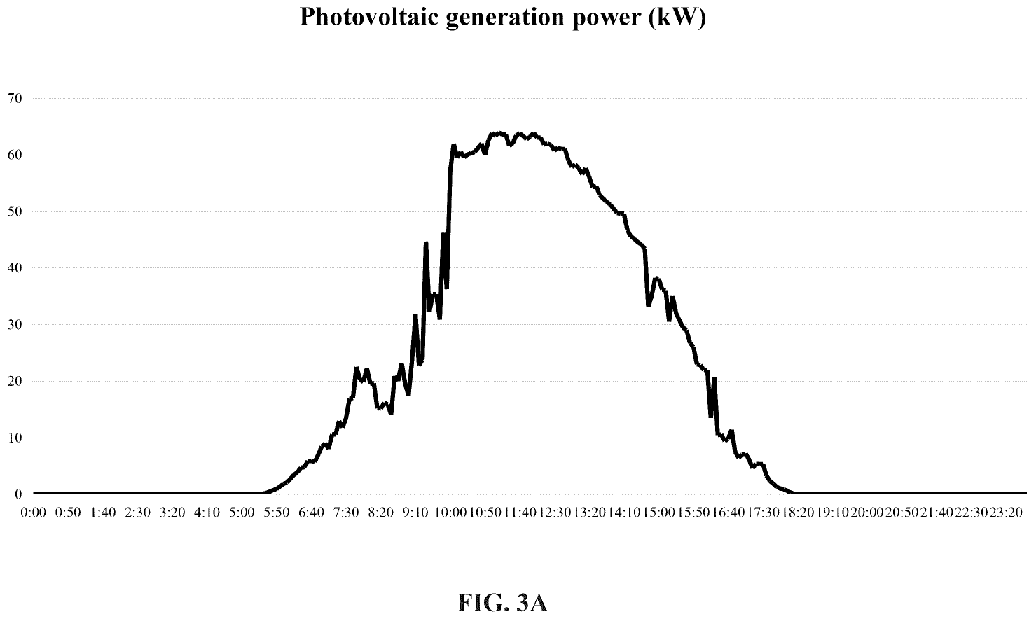

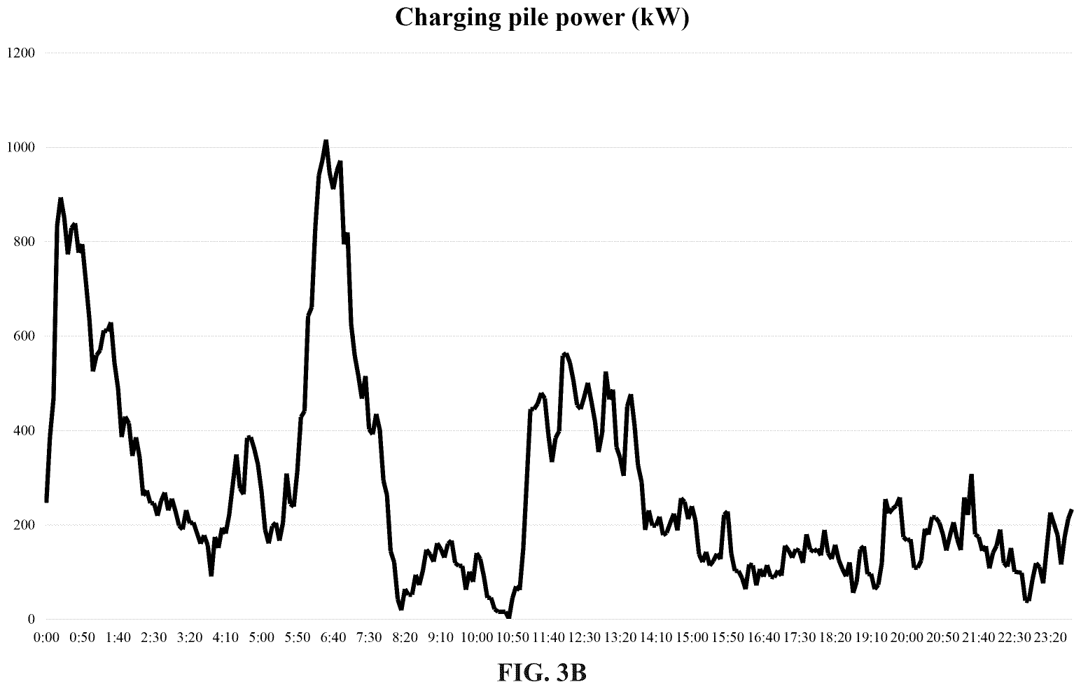

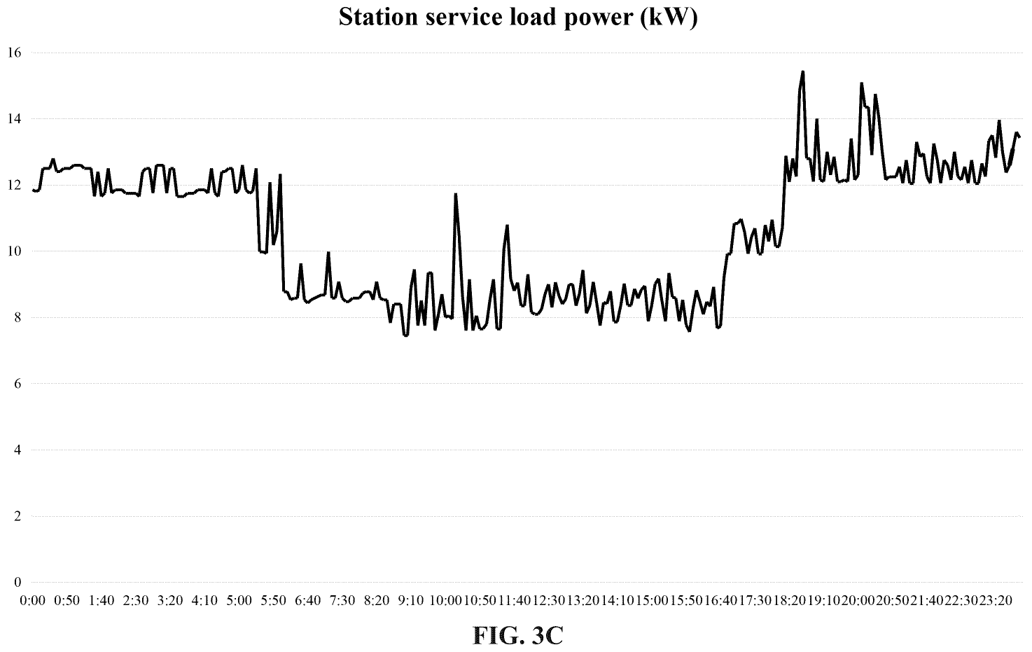

The effect of the method of the present disclosure is demonstrated through a simulation case. In the case, the topology and component configuration of an actual microgrid of a charging-swapping station are shown in FIG. 1. Regarding the specific parameters, the energy storage system has a maximum charging/discharging power of 100 kW, a capacity of 215 kWh, a charging/discharging efficiency of 90%, a SOC range of 0.1 to 1, an initial SOC of 0.1, and a maximum number of charging/discharging times being 2 within a scheduling cycle (24 h). The charging-swapping station has a maximum charging power of 320 kW, a charging efficiency of 90%, and a minimum charged energy of 300 kWh. The grid-connected distribution transformer has a capacity of 2500 kW. The real-time monitored/forecast power curves of the photovoltaic system, the charging pile, and the station service load are shown in FIGS. 3A-3C. The day-ahead/intra-day forecast values of the photovoltaic system, the charging pile, and the station service load are randomly generated, with random error ranges of ±10%/±5%, ±15%/±5%, and ±10%/±5%, respectively. The electricity purchase price is an industrial and commercial electricity price: 1.1566 yuan/kWh in peak periods (8:00 to 11:00 and 17:00 to 22:00), 0.2815 yuan/kWh in the off-peak period (0:00 to 8:00), and 0.6726 yuan/kWh in flat periods (11:00 to 17:00 and 22:00 to 24:00). The electricity sale price is an electricity feed-in tariff for surplus photovoltaic generation, which is 0.391 yuan/kWh. The unit penalty costs μ^{ESdev} and μ^{Swapdev} in Eq. (2) are both set to 0.1 yuan/kWh.

Comparative cases are designed: Case 1 and Case 2. Case 1 uses a fixed control strategy. Specifically, the energy storage system performs two charge cycles and two discharge cycles daily. The two discharge cycles occur during the two peak price periods. Of the two charge cycles, one charge cycle occurs during the nighttime off-peak period, and the other charge cycle occurs during the daytime flat period. Charging and discharging are performed at the maximum charging/discharging power until the SOC reaches the maximum/minimum SOC. The charging-swapping station starts charging at the maximum charging power during the nighttime off-peak period until it is fully charged (i.e., the minimum charged energy is satisfied). Case 2 uses the day-ahead and intra-day multi-time-scale control method of the present disclosure. The control results of the two methods are compared as follows.

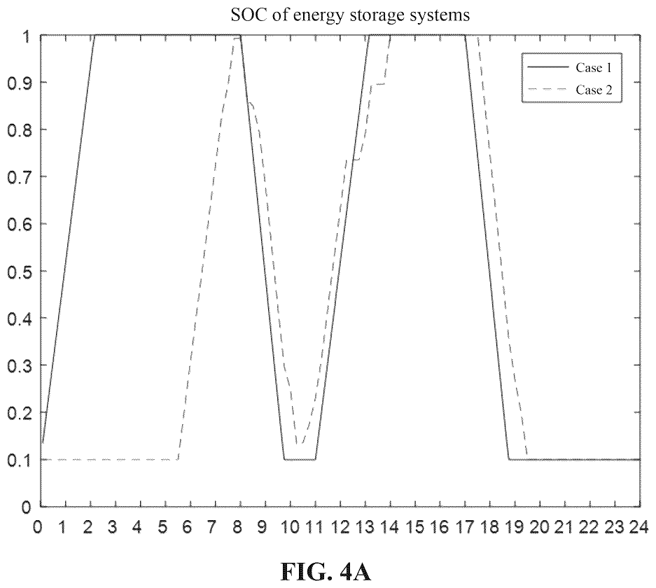

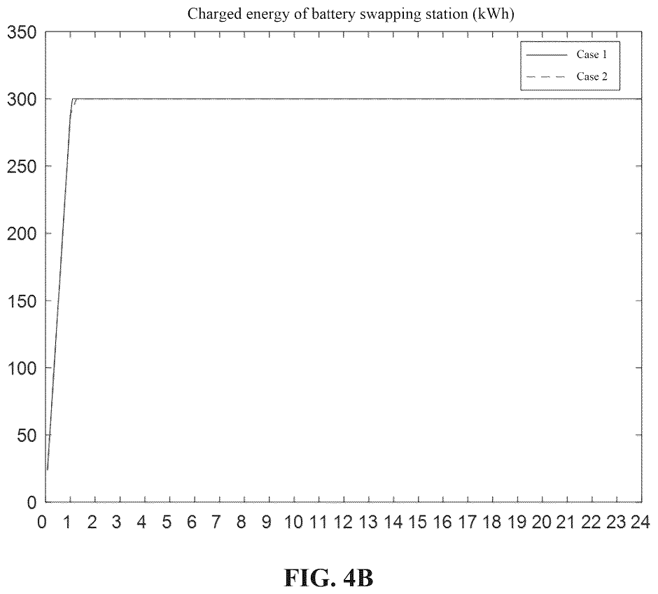

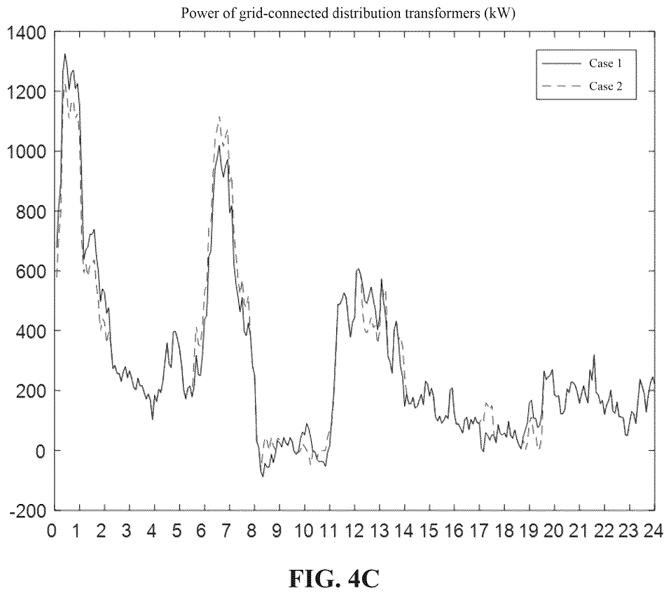

The net electricity purchase costs of Case 1 and Case 2 are 3308.1 yuan and 3294.7 yuan, respectively, indicating that the day-ahead and intra-day multi-time-scale control method of the present disclosure saves the operating cost of the charging-swapping station compared to the fixed control strategy. Regarding the specific reasons, as shown in FIGS. 4A-4C, the two control strategies adopt different charging/discharging power for the energy storage system and different charging power for the charging-swapping station (the main difference lies in the energy storage system). The day-ahead and intra-day multi-time-scale control method of the present disclosure adjusts the power that the microgrid draws from the distribution transformer by flexibly controlling the charging/discharging power of the energy storage system. Thus, the maximum power that the microgrid draws from the distribution transformer and the load rate of the distribution transformer are reduced, while the power fed back from the photovoltaic system to the microgrid during the morning charging load peak is reduced, overall lowering the net electricity purchase cost. The case results verify the effectiveness of the control method of the present disclosure.

An embodiment of the present disclosure provides a computer device, including a memory, a processor, and a computer program stored on the memory and executable on the processor. The computer program is executed by the processor to implement the day-ahead and intra-day multi-time-scale optimal control method for a microgrid of a charging-swapping station.

An embodiment of the present disclosure provides a computer-readable storage medium, configured to store a computer program. The computer program is executed by a processor to implement the day-ahead and intra-day multi-time-scale optimal control method for a microgrid of a charging-swapping station.

An embodiment of the present disclosure provides a computer program product, including a computer program and/or command. The computer program and/or command is executed by a processor to implement the day-ahead and intra-day multi-time-scale optimal control method for a microgrid of a charging-swapping station.

Those skilled in the art should understand that the embodiments of the present disclosure may be provided as a method, a system, or a computer program product. Therefore, the present disclosure may use a form of hardware only embodiments, software only embodiments, or embodiments with a combination of software and hardware. Moreover, the present disclosure may be in a form of a computer program product that is implemented on one or more computer-usable storage media (including but not limited to a magnetic disk memory, a CD-ROM, an optical memory, and the like) that include computer-usable program code.

The present disclosure is described with reference to the flowcharts and/or block diagrams of the method, the device (system), and the computer program product according to the embodiments of the present disclosure. It should be understood that computer program commands may be used to implement each process and/or each block in the flowcharts and/or the block diagrams and a combination of a process and/or a block in the flowcharts and/or the block diagrams. These computer program commands may be provided for a general-purpose computer, a dedicated computer, an embedded processor, or a processor of another programmable data processing device to generate a machine, such that the commands executed by a computer or a processor of another programmable data processing device generate an apparatus for implementing a specific function in one or more processes in the flowcharts and/or in one or more blocks in the block diagrams.

These computer program commands may be stored in a computer-readable memory that can instruct a computer or another programmable data processing device to work in a specific manner, such that the commands stored in the computer-readable memory generate an artifact that includes a command apparatus. The command apparatus implements a specific function in one or more processes in the flowcharts and/or in one or more blocks in the block diagrams.

These computer program commands may alternatively be loaded onto a computer or another programmable data processing device, such that a series of operations and steps are performed on the computer or the another programmable device, thereby generating computer-implemented processing. Therefore, the commands executed on the computer or another programmable device provide steps for implementing a specific function in one or more processes in the flowcharts and/or in one or more blocks in the block diagrams.

What is claimed is:

1. A day-ahead and intra-day multi-time-scale optimal control method for a microgrid of a charging-swapping station, comprising following steps:
step 1: acquiring a day-ahead scheduling plan based on a day-ahead optimal scheduling model, wherein the day-ahead optimal scheduling model is configured to acquire, on a day before a scheduling control day, the day-ahead scheduling plan for a next day, according to short-term power forecast data of a next-day renewable energy output and short-term power forecast data of a next-day load, with an objective of minimizing a net electricity purchase cost;
step 2: acquiring an intra-day rolling scheduling plan based on an intra-day rolling optimal scheduling model, wherein the intra-day rolling optimal scheduling model is configured to acquire, on the scheduling control day, the intra-day rolling scheduling plan within a rolling time window, according to ultra-short-term power forecast data of a renewable energy output and ultra-short-term power forecast data of a load, with an objective of minimizing a sum of the net electricity purchase cost, an energy adjustment penalty cost for energy storage systems between the day-ahead scheduling plan and the intra-day rolling scheduling plan, and an energy deviation penalty cost for the charging-swapping station between the day-ahead scheduling plan and the intra-day rolling scheduling plan; and
step 3: acquiring a real-time control command based on a real-time feedback adjustment control model, wherein the real-time feedback adjustment control model is configured to acquire, on the scheduling control day, the real-time control command for a controllable component in a current time period, according to real-time monitoring data of the renewable energy output and a load power, with an objective of minimizing a sum of power deviations of distribution transformers, the energy storage systems, and the charging-swapping station between the intra-day rolling scheduling plan and the real-time control command;
wherein an objective function of the day-ahead optimal scheduling model is:
$$min . {C}^{D A} = {\sum }_{i ∈ DT} {\sum }_{t ∈ {T}^{DA}} ( {λ}_{t}^{buy} {P}_{i , t}^{DT +} Δ t - {λ}_{t}^{sell} {P}_{i , t}^{DT -} Δ t )$$
wherein C^{DA} denotes the objective function of the day-ahead optimal scheduling model; DT and T^{DA} denote a set of distribution transformers and a set of day-ahead scheduling time horizons, respectively; t is a loop variable, denoting a t-th time-step;
$${λ}_{t}^{buy} and {λ}_{t}^{sell}$$
denote an electricity purchase price and an electricity sale price per unit energy at the t-th time-step, respectively;
$${P}_{i , t}^{DT +} and {P}_{i , t}^{DT -}$$
denote a power that a microgrid draws from an i-th distribution transformer and a power that the microgrid feeds back to the i-th distribution transformer at the t-th time-step, respectively; and Δt denotes a length of a scheduling time interval;
wherein an objective function of the intra-day rolling optimal scheduling model is:
$$min . {C}^{Roll} = {\sum }_{i ∈ DT} {\sum }_{t ∈ {T}^{Roll}} ( {λ}_{t}^{buy} {P}_{i , t}^{DT +} Δ t - {λ}_{t}^{sell} {P}_{i , t}^{DT} - Δ t ) + {μ}^{ESdev} {\sum }_{i ∈ ES} {\sum }_{t ∈ {T}^{Roll}} \vert {E}_{i , cap}^{ES} {SOC}_{i , t}^{ES} - {E}_{i , cap}^{ES} \overline{{SOC}_{i , t}^{ES}} \vert + {μ}^{Swapdev} {\sum }_{b ∈ BUS} {\sum }_{t ∈ {T}^{Roll}} \vert {E}_{b , t}^{Swap} - \overline{{E}_{b , t}^{Swap}} \vert$$
wherein C^{Roll} denotes the objective function of the intra-day rolling optimal scheduling model; T^{Roll} denotes a set of rolling time horizons; ES denotes a set of energy storage systems; b is a loop variable; BUS denotes a set of buses; μ^{ESdev} denotes an energy adjustment penalty cost coefficient per unit energy for the energy storage systems; μ^{Swapdev} denotes an energy adjustment penalty cost coefficient per unit energy for the charging-swapping station;
$${E}_{i , cap}^{ES}$$
denotes a capacity of an i-th energy storage system;
$${SOC}_{i , t}^{ES}$$
denotes a state of charge (SOC) level of the i-th energy storage system at and end of the t-th time-step in the intra-day rolling scheduling plan;
$$\overline{{SOC}_{{}_{i} , t}^{ES}}$$
denotes a SOC level of the i-th energy storage system at the end of the t-th time-step in the day-ahead scheduling plan;
$${E}_{b , t}^{Swap}$$
denotes charged energy of the charging-swapping station connected to a bus b at the end of the t-th time-step in the intra-day rolling scheduling plan; and
$$\overline{{E}_{b , t}^{Swap}}$$
denotes charged energy of the charging-swapping station connected to the bus b at the end of the t-th time-step in the day-ahead scheduling plan;
wherein an objective function of the real-time feedback adjustment control model is:
$$min . Δ {P}^{dev} = {\sum }_{i ∈ DT} \frac{\vert {P}_{i , {t}_{r}}^{DT} - \vert}{{P}_{i , max}^{DT}} + {\sum }_{i ∈ ES} \frac{\vert {P}_{i , {t}_{r}}^{ESch} - \vert + \vert {P}_{i , {t}_{r}}^{ESdch} - \vert}{{P}_{i , max}^{ES}} + {\sum }_{b ∈ BUS} \frac{\vert {P}_{b , {t}_{r}}^{Swap} - \vert}{{P}_{b , max}^{Swap}}$$
wherein ΔP^{dev} denotes the objective function of the real-time feedback adjustment control model;
$${P}_{i , {t}_{r}}^{DT}$$
denotes an actual control value for a power passing through the i-th distribution transformer at a tᵣ-th time-step in real-time feedback adjustment control,
$${P}_{i , {t}_{r}}^{ESch}$$
denotes an actual control value for a charging power of the i-th energy storage system at the tᵣ-th time-step in real-time feedback adjustment control,
$${P}_{i , {t}_{r}}^{ESdch}$$
denotes an actual control value for a discharging power of the i-th energy storage system at the tᵣ-th time-step in real-time feedback adjustment control, and
$${P}_{b , {t}_{r}}^{Swap}$$
denotes an actual control value for a charging power of the charging-swapping station connected to the bus b at the tᵣ-th time-step in real-time feedback adjustment control;
denotes a planned value for the power passing through the i-th distribution transformer at the tᵣ-th time-step in intra-day rolling optimal scheduling,
denotes a planned value tor the charging power of the i-th energy storage system at the tᵣ-th time-step in intra-day rolling optimal scheduling,
denotes a planned value for the discharging power of the i-th energy storage system at the tᵣ-th time-step in intra-day rolling optimal scheduling, and
denotes a planned value for the charging power of the charging-swapping station connected to the bus b at the tᵣ-th time-step in intra-day rolling optimal scheduling;
$${P}_{i , max}^{DT}$$
denotes a maximum active power capacity of the i-th distribution transformer;
$${P}_{i , max}^{ES}$$
denotes a maximum active power charging/discharging power of the i-th energy storage system; and
$${P}_{b , max}^{Swap}$$
denotes a maximum charging power of the charging-swapping station connected to the bus b;
wherein in the intra-day rolling optimal scheduling model, a constraint for the renewable energy output is:
$${P}_{i , t}^{PV} = {P}_{i , t}^{PVforeID}$$
wherein
$${P}_{i , t}^{PV}$$
denotes the renewable energy output of an i-th photovoltaic system at the t-th time-step in the intra-day rolling optimal scheduling model; and
$${P}_{i , t}^{PVforeID}$$
denotes an ultra-short-term power forecast value for the renewable energy output;
in the intra-day rolling optimal scheduling model, a constraint for a charging power of a charging pile in the charging-swapping station is:
$${P}_{b , t}^{CP} = {P}_{b , t}^{CPforeID}$$
wherein
$${P}_{b , t}^{CP}$$
denotes the charging power or the charging pile connected to the bus b in the intra-day rolling optimal scheduling model; and
$${P}_{b , t}^{CPforeID}$$
denotes an intra-day ultra-short-term power forecast value for the charging power of the charging pile connected to the bus b;
in the intra-day rolling optimal scheduling model, a constraint for a power of a station service load is:
$${P}_{b , t}^{SL} = {P}_{b , t}^{SLforeID}$$
wherein
$${P}_{b , t}^{SL}$$
denotes the power or the station service load connected to the bus b in the intra-day rolling optimal scheduling model; and
$${P}_{b , t}^{SLforeID}$$
denotes an intra-day ultra-short-term power forecast value for the power of the station service load connected to the bus b;
wherein in the real-time feedback adjustment control model, a constraint for the renewable energy output is:
$${P}_{i , {t}_{r}}^{PV} = {P}_{i , {t}_{r}}^{PVrt}$$
wherein
$${P}_{i , {t}_{r}}^{PV}$$
denotes an output of the i-th photovoltaic system at a current tᵣ-th time-step; and
$${P}_{i , {t}_{r}}^{PVrt}$$
denotes a real-time monitored value for the output of the i-th photovoltaic system at the current tᵣ-th time-step;
in the real-time feedback adjustment control model, a constraint for a charging power of charging piles in the charging-swapping station is:
$${P}_{b , {t}_{r}}^{CP} = {P}_{b , {t}_{r}}^{CPrt}$$
wherein
$${P}_{b , {t}_{r}}^{CP}$$
denotes the charging power of all the charging piles connected to the bus b at the current tᵣ-th time-step; and
$${P}_{b , {t}_{r}}^{CPrt}$$
denotes a real-time monitored value for the charging power of all the charging piles connected to the bus b at the current tᵣ-th time-step;
in the real-time feedback adjustment control model, a constraint for a power of a station service load is:
$${P}_{b , {t}_{r}}^{SL} = {P}_{b , {t}_{r}}^{SLrt}$$
wherein
$${P}_{b , {t}_{r}}^{SL}$$
denotes the power of the station service load connected to the bus b at the tᵣ-th time-step, and
$${P}_{b , {t}_{r}}^{SLrt}$$
denotes a real-time monitored value for the power of the station service load connected to the bus b at the tᵣ-th time-step.

2. The day-ahead and intra-day multi-time-scale optimal control method for the microgrid of the charging-swapping station according to claim 1, wherein an overall operation constraint for the microgrid of the charging-swapping station is:
$${\sum }_{i ∈ DT ⋂ \{ b \}} {P}_{i , t}^{DT} + {\sum }_{i ∈ PV ⋂ \{ b \}} {P}_{i , t}^{PV} + {\sum }_{i ∈ ES ⋂ \{ b \}} ( {P}_{i , t}^{ESdch} - {P}_{i , t}^{ESch} ) = {P}_{b , t}^{CP} + {P}_{b , t}^{Swap} + {P}_{b , t}^{SL}$$
wherein
$${P}_{i , t}^{DT}$$
denotes an active power of the i-th distribution transformer at the t-th time-step;
$${P}_{i , t}^{ESch} and {P}_{i , t}^{ESdch}$$
denote the charging power and the discharging power of the i-th energy storage system at the t-th time-step, respectively;
$${P}_{b , t}^{Swap}$$
denotes the charging power of the charging-swapping station connected to the bus b at the t-th time-step; DT∩{b} denotes a set of distribution transformers connected to the bus b; PV∩{b} denotes a set of photovoltaic systems connected to the bus b; and ES∩{b} denotes a set of energy storage systems connected to the bus b.

3. The day-ahead and intra-day multi-time-scale optimal control method for the microgrid of the charging-swapping station according to claim 1, wherein in the intra-day rolling optimal scheduling model, constraints for charging and discharging states of the energy storage systems are:
$${x}_{i , t}^{ESch} = \overline{{x}_{i , t}^{ESch}}$$
$${x}_{i , t}^{ESdch} = \overline{{x}_{i , t}^{ESdch}}$$
wherein
$${x}_{i , t}^{ESch} and {x}_{i , t}^{ESdch}$$
denote a charging state and a discharging state of the i-th energy storage system at the t-th time-step within a rolling time cycle, respectively; and
$$\overline{{x}_{{}_{i} , t}^{ESch}} and \overline{{x}_{{}_{i} , t}^{ESdch}}$$
denote a planned charging state and a planned discharging state of the i-th energy storage system at the t-th time-step in the day-ahead scheduling plan, respectively;
in the intra-day rolling optimal scheduling model, a SOC constraint for the energy storage systems is:
$${SOC}_{i , 0 , {r}_{1}}^{ES} = {SOC}_{i , ini}^{ES}$$
$${SOC}_{i , 0 , {r}_{1}}^{ES} = ; {r}_{i} ∈ Roll \backslash \{ {r}_{1} \}$$
$${SOC}_{i , {t}_{end} , {\{ {r}_{i} \}}_{end}}^{ES} \geq {SOC}_{i , ini}^{ES}$$
wherein
$${SOC}_{i , 0 , {r}_{1}}^{ES}$$
denotes a SOL or the i-th energy storage system at an initial time of a first rolling optimization cycle;
$${SOC}_{i , ini}^{ES}$$
denotes an actual SOC of the i-th energy storage system at a beginning of a first time horizon;
$${SOC}_{i , 0 , {r}_{i}}^{ES}$$
denotes a SOC of the i-th energy storage system at an initial time of a rᵢ-th rolling optimization cycle; rᵢ∈Roll\{r₁} denotes that the rᵢ-th rolling optimization cycle is a remaining rolling optimization cycle except the first rolling optimization cycle;
denotes an actual SOC of the i-th energy storage system at an end of a first time period of a previous rolling optimization cycle rᵢ−1; and
$${SOC}_{i , {t}_{end} , {\{ {r}_{i} \}}_{end}}^{ES}$$
denotes an ending SOC of the i-th energy storage system in a rolling optimization cycle {rᵢ}_{end} comprising a final time t_{end}.

4. A computer device, comprising: a memory, a processor, and a computer program stored on the memory and executable on the processor, wherein the computer program is executed by the processor to implement the day-ahead and intra-day multi-time-scale optimal control method for the microgrid of the charging-swapping station according to claim 1.

5. A computer-readable storage medium, configured to store a computer program, wherein the computer program is executed by a processor to implement the day-ahead and intra-day multi-time-scale optimal control method for the microgrid of the charging-swapping station according to claim 1.

6. A computer program product, comprising: a computer program and/or command, wherein the computer program and/or command is executed by a processor to implement the day-ahead and intra-day multi-time-scale optimal control method for the microgrid of the charging-swapping station according to claim 1.

7. The computer device according to claim 4, wherein in the day-ahead and intra-day multi-time-scale optimal control method, an overall operation constraint for the microgrid of the charging-swapping station is:
$${\sum }_{i ∈ DT ⋂ \{ b \}} {P}_{i , t}^{DT} + {\sum }_{i ∈ PV ⋂ \{ b \}} {P}_{i , t}^{PV} + {\sum }_{i ∈ ES ⋂ \{ b \}} ( {P}_{i , t}^{ESdch} - {P}_{i , t}^{ESch} ) = {P}_{b , t}^{CP} + {P}_{b , t}^{Swap} + {P}_{b , t}^{SL}$$
wherein
$${P}_{i , t}^{DT}$$
denotes an active power of the i-th distribution transformer at the t-th time-step;
$${P}_{i , t}^{ESch} and {P}_{i , t}^{ESdch}$$
denote the charging power and the discharging power of the i-th energy storage system at the t-th time-step, respectively;
$${P}_{b , t}^{Swap}$$
denotes the charging power of the charging-swapping station connected to the bus b at the t-th time-step; DT∩{b} denotes a set of distribution transformers connected to the bus b; PV∩{b} denotes a set of photovoltaic systems connected to the bus b; and ES∩{b} denotes a set of energy storage systems connected to the bus b.

8. The computer device according to claim 4, wherein in the day-ahead and intra-day multi-time-scale optimal control method, in the intra-day rolling optimal scheduling model, constraints for charging and discharging states of the energy storage systems are:
$${x}_{i , t}^{ESch} = \overline{{x}_{i , t}^{ESch}}$$
$${x}_{i , t}^{ESdch} = \overline{{x}_{i , t}^{ESdch}}$$
wherein
$${x}_{i , t}^{ESch} and {x}_{i , t}^{ESdch}$$
denote a charging state and a discharging state of the i-th energy storage system at the t-th time-step within a rolling time cycle, respectively; and
$$\overline{{x}_{i , t}^{ESch}} and \overline{{x}_{i , t}^{ESdch}}$$
denote a planned charging state and a planned discharging state of the i-th energy storage system at the t-th time-step in the day-ahead scheduling plan, respectively;
in the intra-day rolling optimal scheduling model, a SOC constraint for the energy storage systems is:
$${SOC}_{i , 0 , {r}_{1}}^{ES} = {SOC}_{i , ini}^{ES}$$
$${SOC}_{i , 0 , {r}_{1}}^{ES} = ; {r}_{i} ∈ Roll \backslash \{ {r}_{1} \}$$
$${SOC}_{i , {t}_{end} , {\{ {r}_{i} \}}_{end}}^{ES} \geq {SOC}_{i , ini}^{ES}$$
wherein
$${SOC}_{i , 0 , {r}_{i}}^{ES}$$
denotes a SOC of the i-th energy storage system at an initial time of a first rolling optimization cycle;
$${SOC}_{i , i n i}^{E S}$$
denotes an actual SOC or the i-th energy storage system at a beginning of a first time horizon;
$${SOC}_{i , 0 , {r}_{i}}^{E S}$$
denotes a SOC of the i-th energy storage system at an initial time of a rᵢ-th rolling optimization cycle; rᵢ∈Roll\{r₁} denotes that the rᵢ-th rolling optimization cycle is a remaining rolling optimization cycle except the first rolling optimization cycle;
denotes an actual SOC of the i-th energy storage system at an end of a first time period of a previous rolling optimization cycle rᵢ−1; and
$${SOC}_{i , {t}_{end} , {\{ {r}_{i} \}}_{end}}^{E S}$$
denotes an ending SOC of the i-th energy storage system in a rolling optimization cycle {rᵢ}_{end} comprising a final time t_{end}.

9. The computer-readable storage medium according to claim 5, wherein in the day-ahead and intra-day multi-time-scale optimal control method, an overall operation constraint for the microgrid of the charging-swapping station is:
$${\sum }_{i ∈ D T ∩ \{ b \}} {P}_{i , t}^{D T} + {\sum }_{i ∈ P V ∩ \{ b \}} {P}_{i , t}^{P V} + {\sum }_{i ∈ E S ∩ \{ b \}} ( {P}_{i , t}^{E S d c h} - {P}_{i , t}^{E Sch} ) = {P}_{b , t}^{CP} + {P}_{b , t}^{Swap} + {P}_{b , t}^{SL}$$
wherein
$${P}_{i , t}^{D T}$$
denotes an active power or the i-th distribution transformer at the t-th time-step;
$${P}_{i , t}^{E S c h} and {P}_{i , t}^{E S d c h}$$
denote the charging power and the discharging power of the i-th energy storage system at the t-th time-step, respectively;
$${P}_{b , t}^{Swap}$$
denotes the charging power of the charging-swapping station connected to the bus b at the t-th time-step; DT∩{b} denotes a set of distribution transformers connected to the bus b; PV∩{b} denotes a set of photovoltaic systems connected to the bus b; and ES∩{b} denotes a set of energy storage systems connected to the bus b.

10. The computer-readable storage medium according to claim 5, wherein in the day-ahead and intra-day multi-time-scale optimal control method, in the intra-day rolling optimal scheduling model, constraints for charging and discharging states of the energy storage systems are:
$${x}_{i , t}^{E S c h} = \overline{{x}_{i , t}^{E S c h}}$$
$${x}_{i , t}^{E S d c h} = \overline{{x}_{i , t}^{E S d c h}}$$
wherein
$${x}_{i , t}^{E S c h} and {x}_{i , t}^{ESdch}$$
denote a charging state and a discharging state of the i-th energy storage system at the t-th time-step within a rolling time cycle, respectively; and
$$\overline{{x}_{{i}_{} , t}^{E S c h}} and \overline{{x}_{{i}_{} , t}^{ESdch}}$$
denote a planned charging state and a planned discharging state of the i-th energy storage system at the t-th time-step in the day-ahead scheduling plan, respectively;
in the intra-day rolling optimal scheduling model, a SOC constraint for the energy storage systems is:
$${SOC}_{i , 0 , {r}_{1}}^{E S} = {SOC}_{i , ini}^{E S}$$
$${SOC}_{i , 0 , {r}_{i}}^{E S} = ; {r}_{i} ∈ Roll ∖ \{ {r}_{1} \}$$
$${SOC}_{i , {t}_{e n d} , {\{ {r}_{i} \}}_{e n d}}^{E S} \geq {SOC}_{i , ini}^{E S}$$
wherein
$${SOC}_{i , 0 , {r}_{1}}^{E S}$$
denotes a SOC of the i-th energy storage system at an initial time of a first rolling optimization cycle;
$${SOC}_{i , i n i}^{E S}$$
denotes an actual SOC of the i-th energy storage system at a beginning of a first time horizon;
$${SOC}_{i , 0 , {r}_{i}}^{E S}$$
denotes a SOC or the i-th energy storage system at an initial time of a rᵢ-th rolling optimization cycle; rᵢ∈Roll\{r₁} denotes that the rᵢ-th rolling optimization cycle is a remaining rolling optimization cycle except the first rolling optimization cycle;
denotes an actual SOC or the i-th energy storage system at an end of a first time period of a previous rolling optimization cycle rᵢ−1; and
$${SOC}_{i , {t}_{end} , {\{ {r}_{i} \}}_{end}}^{ES}$$
denotes an ending SOC of the i-th energy storage system in a rolling optimization cycle {rᵢ}_{end} comprising a final time t_{end}.

11. The computer program product according to claim 6, wherein in the day-ahead and intra-day multi-time-scale optimal control method, an overall operation constraint for the microgrid of the charging-swapping station is:
$${\sum }_{i ∈ D T ∩ \{ b \}} {P}_{i , t}^{D T} + {\sum }_{i ∈ P V ∩ \{ b \}} {P}_{i , t}^{P V} + {\sum }_{i ∈ E S ∩ \{ b \}} ( {P}_{i , t}^{E S d c h} - {P}_{i , t}^{E Sch} ) = {P}_{b , t}^{C P} + {P}_{b , t}^{Swap} + {P}_{b , t}^{S L}$$
wherein
$${P}_{i , t}^{D T}$$
denotes an active power or the i-th distribution transformer at the t-th time-step;
$${P}_{i , t}^{E S c h} and {P}_{i , t}^{E S d c h}$$
denote the charging power and the discharging power of the i-th energy storage system at the t-th time-step, respectively;
$${P}_{b , t}^{Swap}$$
denotes the charging power of the charging-swapping station connected to the bus b at the t-th time-step; DT∩{b} denotes a set of distribution transformers connected to the bus b; PV∩{b} denotes a set of photovoltaic systems connected to the bus b; and ES∩{b} denotes a set of energy storage systems connected to the bus b.

12. The computer program product according to claim 6, wherein in the day-ahead and intra-day multi-time-scale optimal control method, in the intra-day rolling optimal scheduling model, constraints for charging and discharging states of the energy storage systems are:
$${x}_{i , t}^{ESch} = \overline{{x}_{i , t}^{ESch}}$$
$${x}_{i , t}^{ESdch} = \overline{{x}_{i , t}^{ESdch}}$$
wherein
$${x}_{i , t}^{E S c h} and {x}_{i , t}^{E S d c h}$$
denote a charging state and a discharging state of the i-th energy storage system at the t-th time-step within a rolling time cycle, respectively; and
$$\overline{{x}_{{i}_{} , t}^{E S c h}} and \overline{{x}_{{i}_{} , t}^{E S d c h}}$$
denote a planned charging state and a planned discharging state of the i-th energy storage system at the t-th time-step in the day-ahead scheduling plan, respectively;
in the intra-day rolling optimal scheduling model, a SOC constraint for the energy storage systems is:
$${SOC}_{i , 0 , {r}_{1}}^{E S} = {SOC}_{i , ini}^{E S}$$
$${SOC}_{i , 0 , {r}_{i}}^{E S} = ; {r}_{i} ∈ Roll ∖ \{ {r}_{1} \}$$
$${SOC}_{i , {t}_{e n d} , {\{ {r}_{i} \}}_{e n d}}^{E S} \geq {SOC}_{i , ini}^{E S}$$
wherein
$${SOC}_{i , 0 , {r}_{1}}^{E S}$$
denotes a SOC of the i-th energy storage system at an initial time of a first rolling optimization cycle;
$${SOC}_{i , i n i}^{E S}$$
denotes an actual SOC of the i-th energy storage system at a beginning of a first time horizon;
$${SOC}_{i , 0 , {r}_{i}}^{E S}$$
denotes a SOC of the i-th energy storage system at an initial time of a rᵢ-th rolling optimization cycle; rᵢ∈Roll\{r₁} denotes that the rᵢ-th rolling optimization cycle is a remaining rolling optimization cycle except the first rolling optimization cycle;
denotes an actual SOC of the i-th energy storage system at an end of a first time period of a previous rolling optimization cycle rᵢ−1; and
$${SOC}_{i , {t}_{end} , {\{ {r}_{i} \}}_{end}}^{E S}$$
denotes an ending SOC of the i-th energy storage system in a rolling optimization cycle {rᵢ}_{end} comprising a final time t_{end}.
